(19) United States
(12) Patent Application Publication
(10) Pub. No.: US 2015/0032418 A1
(43) Pub. Date: Jan. 29, 2015

(54) AGGREGATING AND FILTERING DATA FROM MOBILE DEVICES

(71) Applicant: INTERNATIONAL BUSINESS MACHINES CORPORATION, Armonk, NY (US)

(72) Inventors: Kazuhito Akiyama, Tokyo (JP); Yuhji Yamashita, Yamato (JP)

(21) Appl. No.: 14/332,607

(22) Filed: Jul. 16, 2014

(30) Foreign Application Priority Data
Jul. 25, 2013 (JP) 2013-154756

(51) Int. Cl. G06F 17/30; G01D 11/00

(52) U.S. Cl. CPC G06F 17/30595; G01D 11/00
USPC 702/190

(57) ABSTRACT

Data from movable devices, each of which has at least one sensor, is aggregated using a method comprising: receiving data from multiple movable devices, where each datum from the data is generated by at least one sensor within a movable device from the multiple movable devices; determining, based on received data from the multiple movable devices, whether at least two movable devices from the multiple movable devices are mutually related; determining, based on received data from the multiple movable devices, whether the received data from different sensors are mutually related; and filtering at least a part of the data from the multiple movable devices judged to be mutually related and that was generated by sensors that are mutually related according to shared attributes of the multiple movable devices and the sensors in the multiple movable devices.

### BACKGROUND

The present invention relates to a technique for aggregating pieces of data from mobile bodies provided with a sensor and performing filtering processing.

Recently, every movable apparatus (hereinafter also referred to as a “mobile body” and/or a “mobile device”), for example, an in-vehicle apparatus, car navigation system, smartphone, mobile phone, tablet terminal, personal computer, health-care apparatus, pedometer, clock, digital camera or digital video apparatus is mounted with some sensor. Each sensor of the mobile body measures or acquires data and transmits the measured or acquired data, for example, to a server, for example, via wireless communication.

For example, in a car, dozens of kinds of sensors are used as key parts per car. The sensors mounted on a car are provided with, in addition to processing for converting change in a physical quantity or a chemical quantity to an electrical signal, which is the original function of the sensors, functions of signal correction processing for amplifying and compensating the signal, operation processing for converting the signal to a function which can be easily handled, information processing for control, and control processing for transmitting the signal to a control target. Furthermore, recently, there are a lot of smart sensors which are made intelligent by a microcomputer being mounted on the sensor side.

Recently, a solution for collecting a huge amount of data, which is called big data, and effectively using the collected huge amount of data is expected. The huge amount of data includes data from the sensors described above.

However, since sensors of apparatuses often measure data of the same target, data measured by the apparatuses include a lot of overlapping data. There is variation in, for example, the precision or accuracy of measured data among the apparatuses, and data loss often occurs. Furthermore, normalization of data collected by the sensors provided in the apparatuses has not progressed.

Relationships among the sensors provided in the apparatuses are not specified, and, therefore, the current situation is that there are a lot of so-called “stray sensors” disorderly.

Furthermore, while the amount of data collected by the sensors provided in the apparatuses increases more and more, network infrastructures for collecting the data have not been sufficiently established.

It is promoted to legitimize collection of various data from sensors provided in various apparatuses and reporting of the collected data.

In the known prior art a method for performing position estimation about a mobile body using a sensor more favorably is described.

Known prior art describes a method for adjusting estimation of the position of a wireless base of a mobile station, using a relative motion sensor, and the method includes steps of: estimating the position of the mobile station on the basis of a wireless signal measured value; measuring movement of the mobile station using the relative motion sensor; detecting displacement of the mobile station on the basis of the measured movement; determining that the displacement is below a threshold; adjusting the estimated position of the mobile station using information from the relative motion sensor; detecting that the displacement substantially does not exist on the basis of data of the movement; determining an updated position of the mobile station on the basis of an additional wireless signal measured value; and combining the estimated position of the mobile station and the updated position in order to bring about improved position estimation; and the step of combining the estimated position of the mobile station and the updated position further includes a step of performing filtering of multiple measured values of a position derived by using the wireless signal measured value in order to elaborate processing delay related to a wireless access point.

Known prior art shown describes that an estimate position is calculated by performing a predicted position coordinates calculating process by a predicted position coordinates calculating section, the position of a transmitter at the time stamp being predicted on the basis of the track of the transmitter in this process and the track of the transmitter being managed by a transmitter track information storage section; and by calculating, for example, a movement vector leading to the previous position and adding the movement vector to the previous position coordinates.

Known prior art shown describes a position estimation apparatus including a mathematical model processing section acquiring posture information and position/positioning information about a mobile body from a sensor and calculating the position of the mobile body on the basis of the acquired posture information and position/positioning information, on the basis of a mathematical model indicating a behavior of the mobile body provided in advance, wherein the mathematical model processing section includes multiple mathematical models; and the position calculation apparatus includes: a threshold calculating section calculating a candidate value for a threshold using an error calculated by filtering processing using a probability model in the mathematical model processing section calculating a position; a threshold determining section determining the threshold for selecting a mathematical model on the basis of the candidate value; and a mathematical model selecting section selecting a mathematical model used by the mathematical model processing section for position calculation on the basis of the threshold determined by the threshold determining section.

Known prior art shown describes a navigation apparatus determining a traveling position of a mobile body using a speed sensor detecting the speed of the mobile body, one or more sensors detecting a physical quantity indicating a motion of the mobile body other than the speed, and outputs from a sensors group including the sensors and the speed sensor, the navigation apparatus including: filter processing means for performing filter processing having a predetermined filter characteristic for the outputs from the sensors group and calculating an estimated value using a result of the processing; sensor error evaluating means for evaluating an error of outputs from one or more sensors using any one or more among outputs from the one or more sensors other than the speed sensor and an estimated value outputted from the filter processing means, and a filter gain calculating means for calculating a filter gain that adjusts the filter characteristic of the filter processing means, on the basis of an output of the sensor error estimating means.

Known prior art describes an in-vehicle sensor information use program to be caused to function as reliability calculating means for calculating the reliability of sensor information on the basis of the sensor information and basic information which have been provided.

### SUMMARY

In one embodiment of the present invention, a method and/or computer program product is used for aggregating data from movable devices, wherein each of the movable devices comprises at least one sensor, wherein each of the movable devices is capable of performing filtering processing. The method comprises: receiving, by one or more processors, data from multiple movable devices, wherein each datum from the data is generated by at least one sensor within a movable device from the multiple movable devices; determining, by one or more processors and based on received data from the multiple movable devices, whether at least two movable devices from the multiple movable devices are mutually related; determining, by one or more processors and based on received data from the multiple movable devices, whether the received data from different sensors are mutually related; and filtering, by one or more processors, at least a part of the data from the multiple movable devices judged to be mutually related and that was generated by sensors that are mutually related according to shared attributes of the multiple movable devices and the sensors in the multiple movable devices.

In one embodiment of the present invention, an apparatus for aggregating data from movable devices, wherein each of the movable devices comprises at least one sensor, wherein each of the movable devices is capable of performing filtering processing, and wherein the apparatus comprises: a hardware receiver for receiving data from multiple movable devices, wherein each datum from the data is generated by at least one sensor within a movable device from the multiple movable devices; a first hardware determining device for determining, based on received data from the multiple movable devices, whether at least two movable devices from the multiple movable devices are mutually related; a second hardware determining device for determining, based on received data from the multiple movable devices, whether the received data from different sensors are mutually related; and a filtering hardware device for filtering at least a part of the data from the multiple movable devices judged to be mutually related and that was generated by sensors that are mutually related according to shared attributes of the multiple movable devices and the sensors in the multiple movable devices.

### BRIEF DESCRIPTION OF THE SEVERAL VIEWS OF THE DRAWINGS

FIG. 1 is a diagram showing an example of a hardware configuration for realizing a computer (for example, a server) which can be used in an embodiment of the present invention;

FIG. 2A is a diagram showing various kinds of mobile bodies which can be used in the embodiment of the present invention and sensors provided in each of the various kinds of mobile bodies;

FIG. 2B is a diagram showing various kinds of mobile bodies which can be used in the embodiment of the present invention and sensors provided in each of the various kinds of mobile bodies;

FIG. 2C is a diagram showing various kinds of mobile bodies which can be used in the embodiment of the present invention and sensors provided in each of the various kinds of mobile bodies;

FIG. 3 is a diagram showing, for a solution for following persons' movements in a city, a scenario of aggregating data from mobile bodies related to the persons and performing filtering processing, in accordance with the embodiment of the present invention;

FIG. 4 is a diagram showing, for a solution for performing traffic jam management or advertisement distribution, a scenario of aggregating data from mobile bodies related to cars and performing filtering processing, in accordance with the embodiment of the present invention;

FIG. 5 is a diagram showing, for a solution for measuring or estimating the flow (for example, the traffic volume or traffic density) of cars, motorcycles and the like on each road, a scenario of aggregating data from sensors mounted on the cars, motorcycles and the like, and road-side machines provided with a sensor capable of measuring information about the cars and motorcycles, and performing filter processing, in accordance with the embodiment of the present invention;

FIG. 6A shows an example of a general mobile bodies table for registering mobile body information;

FIG. 6B shows each of examples of a table including attribute names for defining attribute values of mobile bodies which can be associated and a table including attribute names for storing attribute values of the associated mobile bodies in a mobile bodies' relations database which can be used in the embodiment of the present invention;

FIG. 7 is a flowchart showing an example of a process executed on a server side in accordance with the embodiment of the present invention;

FIG. 8 is a flowchart showing an example of a process executed on a sensor side in accordance with the embodiment of the present invention;

FIG. 9A is a flowchart showing a process for performing the association on the server side and a process for canceling the association on the server side in accordance with the embodiment of the present invention;

FIG. 9B is a flowchart showing a process for canceling association on the sensor side in accordance with the embodiment of the present invention;

FIG. 10 is a diagram showing an example of a functional block diagram of a computer (for example, a server) which is preferably provided with the hardware configuration in accordance with FIG. 1 and which is in accordance with the embodiment of the present invention;

FIG. 11A is a diagram showing an example of a functional block diagram of a sensor which can be used in the embodiment of the present invention; and

FIG. 11B is a diagram showing an example of a functional block diagram of a sensor which can be used in the embodiment of the present invention.

### DETAILED DESCRIPTION

Data collected by a sensor provided in each apparatus includes a lot of abnormal values, and, sometimes, the data does not include all values necessary for analysis. For example, it is said that 30 percent of data from in-vehicle electronic control units (ECUs) is abnormal values. Furthermore, data differs in the precision, accuracy, collection intervals or necessary attributes according to the kind and setting of the sensor provided in each apparatus. Therefore, a computer collecting the data is required, for example, to normalize the data or perform filtering of the data in order to handle the great amount of data. The computer is also required to supplement pieces of data from multiple sensors with one another to obtain data necessary for analysis or collect high-precision data from the collected data.

If attempting to collect all data collected by sensors of apparatuses, a load is given to a network infrastructure and a storage infrastructure. Therefore, it is necessary to reduce the load on the network infrastructure for data collection and the load on the storage, and further reduce the load on succeeding processing by performing filtering processing of overlapping pieces of data among data from multiple sensors.

There may be a case where, since a result derived on the basis of data collected from sensors of apparatuses is an unexpected result, it is necessary to supplement data.

Therefore, the object of the present invention is to effectively use data obtained from mobile bodies by dynamically associating multiple mobile bodies or dynamically associating pieces of data about at least one mobile body from different sensors and performing filtering processing of at least a part of pieces of data from sensors provided in the mutually associated mobile bodies or at least a part of the mutually associated pieces of data.

In one embodiment of the present invention, a method, system, and/or computer program product provides a technique for aggregating pieces of data from one or more mobile bodies each of which is provided with at least one sensor and performing filtering process. The technique includes a method for aggregating pieces of data from one or more mobile bodies each of which is provided with at least one sensor, and performing filtering process, and a computer, a computer program, and a computer program product for the method.

The present invention also provides a data collection system provided with one or more mobile bodies each of which is provided with at least one sensor, and a computer aggregating pieces of data from the mobile bodies and performing filtering process.

In a first aspect according to the present invention, a method for aggregating pieces of data from multiple mobile bodies each of which is provided with at least one sensor and performing filtering processing includes a computer executing the steps of: receiving pieces of data from the sensors, from the multiple respective mobile bodies; judging whether at least two mobile bodies among the multiple mobile bodies are mutually related mobile bodies on the basis of the received pieces of data; and performing filtering processing of at least a part of the pieces of data from the mobile bodies judged to be mutually related.

In a second aspect according to the present invention, a method for aggregating pieces of data from at least one of mobile bodies each of which is provided with at least one sensor and performing filtering includes a computer executing the steps of: receiving pieces of data from the multiple respective mobile bodies; judging whether pieces of data about at least one mobile body from respective different sensors are mutually related pieces of data, on the basis of the received pieces of data; and performing filtering processing of at least a part of the pieces of data which have been judged to be mutually related and which are the pieces of data about at least one mobile body from the respective different sensors.

In a third aspect according to the present invention, a method for aggregating pieces of data from multiple mobile bodies each of which is provided with at least one sensor and performing filtering processing includes: a computer executing the steps of: receiving pieces of data from the sensors, from the multiple respective mobile bodies judging whether at least two mobile bodies among the multiple mobile bodies are mutually related mobile bodies on the basis of the received pieces of data; and transmitting, to at least one sensor among sensors provided in the mobile bodies judged to be mutually related, an instruction controlling the sensor to perform filtering processing of data; and the sensor that has received the instruction executing the steps of: performing filtering processing of at least a part of the pieces of data on the basis of the instruction; and transmitting data after the filtering processing to the computer.

In a fourth aspect according to the present invention, a method for aggregating pieces of data from at least one of mobile bodies each of which is provided with at least one sensor and performing filtering includes: a computer executing the steps of: receiving pieces of data from the multiple respective mobile bodies; judging whether pieces of data about at least one mobile body from respective different sensors are mutually related pieces of data, on the basis of the received pieces of data; and transmitting, to at least one of the different sensors transmitting the pieces of data judged to be mutually related, an instruction controlling the sensor to perform filtering processing of data; and the sensor that has received the instruction executing the steps of: performing filtering processing of at least a part of the pieces of data on the basis of the instruction; and transmitting data after the filtering processing being performed, to the computer.

In a fifth aspect according to the present invention, a computer aggregating pieces of data from mobile bodies each of which is provided with at least one sensor and performing filtering processing includes: receiving means for receiving pieces of data from the sensor, from the multiple respective mobile bodies; relation judging means for judging whether at least two mobile bodies among the multiple mobile bodies are mutually related mobile bodies on the basis of the received pieces of data; and filtering processing means for performing filtering processing of at least a part of the pieces of data from the mobile bodies judged to be mutually related.

In a sixth aspect according to the present invention, in a method for aggregating pieces of data from at least one of mobile bodies each of which is provided with at least one sensor and performing filtering processing, a computer includes: receiving means for receiving pieces of data from the multiple respective mobile bodies; relation judging means for judging whether pieces of data about at least one mobile body from respective different sensors are mutually related pieces of data, on the basis of the received pieces of data; and filtering processing means for performing filtering processing of at least a part of the pieces of data judged to be mutually related.

In a seventh aspect according to the present invention, a data collection system includes multiple mobile bodies each of which is provided with at least one sensor and a computer aggregating pieces of data from the multiple mobile bodies and performing filtering processing, and the computer including: receiving means for receiving pieces of data from the sensor, from the multiple respective mobile bodies; relation judging means for judging whether at least two mobile bodies among the multiple mobile bodies are mutually related mobile bodies on the basis of the received pieces of data; and filtering control instruction transmitting means for transmitting, to at least one sensor among sensors provided in the mobile bodies judged to be mutually related, an instruction controlling the sensor to perform filtering processing of data; and the sensor that has received the instruction including: filtering processing means for performing filtering processing of at least a part of data from the sensor that has received the instruction, on the basis of the instruction; and data transmitting means for transmitting data after the filtering processing being performed by the filtering processing means, to the computer.

In an eighth aspect according to the present invention, a data collection system includes at least one mobile body provided with at least one sensor and a computer aggregating pieces of data from the at least one mobile body and performing filtering processing; the computer including: receiving means for receiving pieces of data from the multiple respective mobile bodies; relation judging means for judging whether pieces of data about at least one mobile body from respective different sensors are mutually related pieces of data, on the basis of the pieces of data received by the receiving means; and filtering processing control instruction transmitting means for transmitting, to at least one of the different sensors transmitting the pieces of data judged to be mutually related, an instruction controlling the sensor to perform filtering processing of data; and the sensor that has received the instruction including: filtering processing means for performing filtering processing of at least a part of the pieces of data from the respective different sensors on the basis of the instruction; and data transmitting means for transmitting the data after the filtering processing being performed by the filtering processing means, to the computer.

Furthermore, in one embodiment of the present invention, the computer can further include sensor associating means for mutually associating, among sensors provided in the mobile bodies judged to be mutually related or among the different sensors transmitting the pieces of data judged to be mutually related, one sensor as a main sensor with the other sensors as subordinate sensors.

Furthermore, in the one embodiment of the present invention, the computer can further include: (computer-side) relation cancellation judging means for judging whether the relation among the mobile bodies judged to be mutually related or the relation among the pieces of data judged to be mutually related is to be canceled, on the basis of the received pieces of data received by the receiving means; and (computer-side) filtering stopping means for, in response to the relation among the mobile bodies judged to be mutually related or the relation among the pieces of data judged to be mutually related being to be canceled, stopping the step of performing filtering processing.

Furthermore, in the one embodiment of the present invention, the computer can further include: (computer-side) relation cancellation judging means for judging whether the relation among the mobile bodies judged to be mutually related or the relation among the pieces of data judged to be mutually related is to be canceled, on the basis of the pieces of data received by the receiving means; and filtering stopping instruction transmitting means for, in response to the relation among the mobile bodies judged to be mutually related or the relation among the pieces of data judged to be mutually related being to be canceled, transmitting an instruction for stopping the filtering processing, to the sensor that has received the instruction.

Furthermore, in the one embodiment of the present invention, the sensor that has received the instruction can further include: (sensor-side) relation cancellation judging means for judging whether the relation among the mobile bodies judged to be mutually related or the relation among the pieces of data judged to be mutually related is to be canceled; and (sensor-side) filtering stopping means for, in response to the relation among the mobile bodies judged to be mutually related or the relation among the pieces of data judged to be mutually related being to be canceled, stopping the filtering processing.

Furthermore, in the one embodiment of the present invention, the computer can further include: (computer-side) relation cancellation judging means for judging whether the relation among the mobile bodies judged to be mutually related or the relation among the pieces of data judged to be mutually related is to be canceled in the sensor that has received the instruction; and relation cancellation judging information transmitting means for, in response to cancellation of the relation among the mobile bodies judged to be mutually related or the relation among the pieces of data judged to be mutually related being possible in the sensor that has received the instruction, transmitting information for judging cancellation of the relation among the mobile bodies judged to be mutually related or information for judging cancellation of the relation among the pieces of data judged to be mutually related, to the sensor that has received the instruction; and the sensor that has received the instruction can further include (sensor-side) relation cancellation judging means for judging whether or not to cancel the relation among the mobile bodies judged to be mutually related or the relation among the pieces of data judged to be mutually related, on the basis of the information transmitted from the computer and data corresponding to the information from the sensor, in judging whether the relation among the mobile bodies judged to be mutually related or the relation among the pieces of data judged to be mutually related is to be canceled.

Furthermore, in the one embodiment of the present invention, the receiving means provided in the computer can further execute further receiving data from an apparatus collecting data from the mobile bodies or an apparatus provided with a sensor for measuring information about the mobile bodies.

Furthermore, in the one embodiment of the present invention, the relation judging means provided in the computer executes, in the case of judging whether at least two mobile bodies among the multiple mobile bodies are mutually related, at least one of: judging mobile bodies performing the same or similar movements to be related mobile bodies; and judging mobile bodies to be the related mobile bodies on the basis of past history data of being associated as a related mobile body, a mobile bodies' relations database with which the mobile bodies are registered, status conditions of the mobile bodies or owner information about the mobile bodies; and the relation judging means executes, in the case of judging whether pieces of data about at least one mobile body from respective different sensors are mutually related, judging pieces of data to be the mutually related pieces of data on the basis of past history data of pieces of data from the respective different sensors being mutually associated, a mobile bodies' relations database with which the mobile bodies or an apparatus collecting data from the mobile bodies is registered, status conditions of the mobile bodies or the apparatus collecting data from the mobile bodies, or owner information about the mobile bodies or the apparatus collecting data from the mobile bodies.

Furthermore, in the one embodiment of the present invention, the filtering processing means provided in the computer can execute: leaving data from the main sensor, and deleting or discarding data from the subordinate sensors; or supplementing the data from the main sensor with a part of the data from the subordinate sensors.

Furthermore, in the one embodiment of the present invention, the filtering processing means provided in the computer can execute at least one of filtering processes of: deleting or discarding overlapping pieces of data among the pieces of data from the mobile bodies judged to be mutually related or the pieces of data judged to be mutually related; leaving data from a high-precision sensor among the pieces of data from the mobile bodies judged to be mutually related or the pieces of data judged to be mutually related, and deleting or discarding data from the other sensors; comparing collection times of the pieces of data from the mobile bodies judged to be mutually related or the pieces of data judged to be mutually related and, in order that data collection intervals become predetermined collection intervals, leaving a part of the pieces of data while deleting or discarding the remaining pieces of data; deleting or discarding data showing an abnormal value or data for which an attribute associated with the data is inappropriate, among the pieces of data from the mobile bodies judged to be mutually related or the pieces of data judged to be mutually related; supplementing the pieces of data from the mobile bodies judged to be mutually related or the pieces of data judged to be mutually related, with one another to form one data set; and among the pieces of data from the mobile bodies judged to be mutually related or the pieces of data judged to be mutually related, receiving one piece of data and preventing reception of the other pieces of data.

Furthermore, in the one embodiment of the present invention, the filtering control instruction transmitting means provided in the computer can execute: transmitting, to the subordinate sensor, an instruction controlling the sensor to perform filtering processing of the data.

A computer program and a computer program product in accordance with the present invention cause the computer to execute each step of a method in accordance with the present invention.

Each computer program in accordance with the embodiment of the present invention can be stored in any one or more computer-readable recording media, such as flexible disks, MOs, CD-ROMs, DVDs, BDs, hard disk devices, memory media connectable to USB, ROMs, MRAMs, and RAMs. In order to store the computer program into a recording medium, the computer program can be downloaded from another data processing system connected via a communication line, for example, a server computer or copied from another recording medium. Furthermore, the computer program in accordance with the embodiment of the present invention can be compressed or divided in multiple parts and stored in a single or multiple recording media. It should be noted that it is, of course, possible to provide a computer program product in accordance with the embodiment of the present invention in various forms. The computer program product in accordance with the embodiment of the present invention includes, for example, a storage medium in which the computer program is recorded or a transmission medium for transmitting the computer program.

It should be noted that the summary of the invention described above does not enumerate all necessary features of the present invention, and combinations or sub-combinations of the components can also constitute the present invention.

Of course, various alterations are easily assumed by one skilled in the art, such as combining hardware components of the computer used in the embodiment of the present invention with multiple machines and distributing and implementing functions thereto. Those alterations are naturally concepts included in the idea of the present invention. However, the components are merely as examples, and all the components are not necessarily indispensable components of the present invention.

The present invention can be realized as hardware, software or a combination of hardware and software. In execution by a combination of hardware and software, execution in a computer in which the computer program is installed can be given as a typical example. In such a case, by being loaded onto the memory of the computer and executed, the computer program controls the computer and causes the computer to execute a process according to the present invention. The computer program can be configured with a group of instructions which can be expressed in any language, code or notation. Such a group of instructions enables the computer to execute a particular function directly or after any one of or both of 1. conversion to another language, code or notation and 2. duplication to another medium being performed.

In accordance with the embodiment of the present invention, it becomes possible to perform filtering processing of overlapping pieces of data among pieces of data from sensors provided in at least two mutually associated mobile bodies, or mutually associated pieces of data about at least one mobile body from different sensors, on a server side. By performing filtering processing of the overlapping pieces of data on the server side, it becomes possible to reduce the load on the server required for succeeding data processing.

In accordance with the embodiment of the present invention, it becomes possible to perform filtering processing of overlapping pieces of data among pieces of data from sensors provided in at least two mutually associated mobile bodies, or mutually associated pieces of data about at least one mobile body from different sensors, on a sensor side. By performing filtering processing of the overlapping data on the sensor side, it becomes possible to reduce the load on a network used at the time of transmitting the overlapping pieces of data and the amount of data transmission and reduce the load on the sensor required for succeeding data processing.

In accordance with the embodiment of the present invention, it becomes possible to collect only high-precision data by, for pieces of data from sensors provided in at least two mutually associated mobile bodies or for mutually associated pieces of data about at least one mobile body from different sensors, leaving data from a high-precision sensor and deleting data from the other sensors.

In accordance with the embodiment of the present invention, it becomes possible to collect more accurate data by, for pieces of data from sensors provided in at least two mutually associated mobile bodies or for mutually associated pieces of data about at least one mobile body from different sensors, deleting data showing an abnormal value or data for which an attribute associated with the data is inappropriate.

In accordance with the embodiment of the present invention, it becomes possible to configure data collected at predetermined collection intervals by, for pieces of data from sensors provided in at least two mutually associated mobile bodies or for mutually associated pieces of data about at least one mobile body from different sensors, comparing collection times of the pieces of data and, in order that data collection intervals become predetermined collection intervals, leaving a part of the pieces of data while deleting the remaining pieces of data.

In accordance with the embodiment of the present invention, it becomes possible to supplement missing data from a particular sensor with data from another sensor (the remaining data is deleted), or delete an abnormal value from a particular sensor and supplement the abnormal value with a normal value of another sensor, by performing mutual supplementation among pieces of data from sensors provided in at least two mutually associated mobile bodies or among mutually associated pieces of data about at least one mobile body from different sensors.

In accordance with the embodiment of the present invention, it becomes possible to dynamically associate multiple mobile bodies reporting data for the same purpose and perform filtering processing of data transmitted from each of the dynamically associated mobile bodies. Furthermore, in accordance with the embodiment of the present invention, it becomes possible to dynamically cancel the association among the dynamically associated mobile bodies; and, furthermore, dynamically re-associate one mobile body the association of which has been canceled with another mobile body reporting data for the same purpose and perform filtering processing of data transmitted from each of the dynamically re-associated mobile bodies.

In accordance with the embodiment of the present invention, it becomes possible to dynamically associate multiple pieces of data from multiple sensors reporting data about the same mobile body for the same purpose and perform filtering processing of the dynamically associated pieces of data. In accordance with the embodiment of the present invention, it becomes possible to dynamically cancel the association among the dynamically associated pieces of data; and, furthermore, dynamically re-associate the data the association of which has been canceled with data from another sensor reporting data about the same mobile bodies for the same purpose and perform filtering processing of the dynamically re-associated pieces of data.

Embodiments of the present invention will be described below in accordance with the drawings. Through the drawings shown below, the same reference numerals refer to the same object unless otherwise stated. It should be understood that the embodiment of the present invention is intended to describe preferable aspects of the present invention and is not intended to limit the scope of the present invention to what is shown here.

The computer (for example, a server) in accordance with the embodiment of the present invention can be configured with one or multiple computers.

The computer (for example, a server) receives, from each of one or multiple mobile bodies, measurement data (raw data) and image data (including still images or moving images) from at least one sensor provided in each of the mobile bodies and/or processed data obtained by processing the data. Hereinafter, the expression of “data from a mobile body (mobile bodies)” can include the measurement data, image data or processed data described above, or a combination thereof.

The computer (for example, a server) can receive the data from the mobile bodies directly from the mobile bodies or indirectly from another computer or a network storage (for example, NAS (Network Attached Storage) and SAN (Storage Area Network)) which stores the data from the mobile bodies, for example, via a communication line (for example, a wired or wireless communication line). Alternatively, the computer can read the data from the mobile bodies from any one or more computer-readable recording media such as flexible disks, MOs, CD-ROMs, DVDs, BDs, hard disk devices and memory media connectable to USB.

The mobile bodies which can be used in the embodiment of the present invention are not especially limited if they are provided with one or multiple sensors. In addition to mobile bodies provided with a function of moving themselves, the mobile bodies include still bodies which are not provided with the function of moving themselves but are able to move by accompanying or following another mobile body provided with the function of moving itself (for example, every arbitrary vehicles (for example, a car, a train, a bus, a taxi, an airplane, a ship or the like) and a life body including a human being).

The mobile body described above can be, for example, any vehicle, any life body including a human being, an in-vehicle electronic control unit (ECU), a car navigation system, a portable navigation system, a smartphone, a mobile phone, a tablet terminal (for example, an Android® terminal, a Windows® tablet or an iOS terminal), a computer (for example, a notebook computer or a ultrabook tablet), a personal digital assistant (PDA), a medical apparatus terminal, a point-of-sales information management (POS) terminal, a game terminal, a health-care apparatus, a pedometer, a watch or clock, a digital camera, a digital video apparatus and a head mounted display.

The mobile body is provided with, for example, a communication function capable of transmitting (dispatching) data from the mobile body to a server, or another computer or network storage storing data from the mobile body periodically (for example, at predetermined time intervals) or in response to a data transmission request from the server.

The sensor which can be used in the embodiment of the present invention may be any sensor capable of acquiring any kind of data if the sensor can output, for example, a physical or chemical change as an electrical signal. The sensor can be, for example, various kinds of sensors mounted on the mobile body in advance, various kinds of sensors which can be attached later or fit as necessary to the mobile body, various kinds of sensors which can be carried by the mobile body and can move together with the mobile body, a sensor capable of photographing a still image or a moving image, or a sensor provided with a communication function (for example, Bluetooth® or Wi-Fi). The sensor provided with a communication function can be used, for example, as a position sensor or a proximity sensor. The kind of data which can be measured by the sensor includes, for example, position, speed, acceleration, temperature, humidity or height data. However, the data is not limited thereto.

In the embodiment of the present invention, the pieces of data about at least one mobile body from different sensors can be, for the same mobile body, a combination of data about the same mobile body from a sensor provided in the same mobile body and data from an apparatus (which can be a still apparatus or a mobile apparatus) provided with a sensor capable of measuring information about the same mobile body (for example, data for substituting for or supplementing the data from the mobile body) or, for different mobile bodies, a combination of data from sensors provided in the multiple mobile bodies and data from an apparatus capable of measuring data for substituting for or supplementing the data from the different mobile bodies (which can be a still apparatus or a mobile apparatus). The kind of the apparatus does not matter if it is a tangible object provided with a sensor. The apparatus (still apparatus) capable of measuring the data can be, for example, a road-side machine, a road-side sensor, a road-side camera or an Orbis (automatic camera for detecting and recording speeding vehicles provided on a road) provided on a road, a weather sensor (for example, a compound weather sensor), or, for example, a structure provided with a sensor (for example, a monitoring apparatus), such as a road or a facility. The apparatus (movable apparatus) capable of measuring the data can be, for example, a road-side machine or a monitoring apparatus provided on a vehicle.

The computer and the mobile body can be in a client-server relationship.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A text-based visual representation is not a target for natural language processing such as morphological analysis. Therefore, when such a visual representation appears in an electronic document to be analyzed, there is a need to separate between text parts and visual representation parts. However, if information indicated by the visual representation can be extracted, it will be desired in analyzing the document.

However, text-based visual representations representing various contents are being created every day. Even in the case of visual representations that represent the same or similar objects, various variations are created by minute differences (for example, in the case of representations of a person's face, different expressions of faces are easily created by changing a character(s) (symbol(s)) that represent eyes or a mouth). Therefore, it is very difficult to manually create and expand a dictionary in which a meaning is uniformly associated with each visual representation.

The present invention has been made in view of such problems, and it is an object thereof to extract information based on a text-based visual representation accurately from a document including the visual representation.

An embodiment of the present invention will be described in detail below with reference to the accompanying drawings.

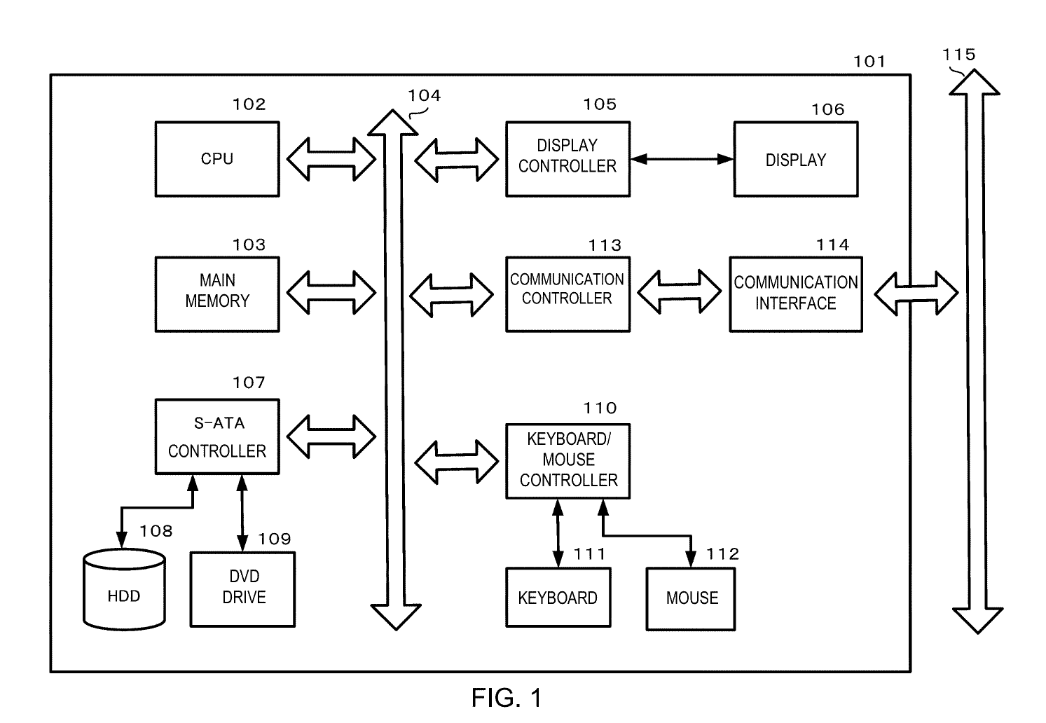

FIG. 1 is a diagram showing an example of a hardware configuration for realizing the computer (for example, a server) which can be used in the embodiment of the present invention.

A computer 101 is provided with a CPU 102 and a main memory 103, which are connected to a bus 104. The CPU 102 is favorably based on a 32-bit or 64-bit architecture. The CPU 102 can be, for example, a CPU of Core™ i series, Core™ 2 series, Atom™ series, Xeon® series, Pentium® series or Celeron® series by Intel Corporation, A series, Phenom™ series, Athlon™ series, Turion™ series or Sempron™ by AMD (Advanced Micro Devices) Inc., or Power™ series by International Business Machines Corporation.

A display (106), for example, a liquid crystal display (LCD) can be connected to the bus (104) via a display controller (105). The liquid crystal display (LCD) may be, for example, a touch panel display or a floating touch display. The display (106) can be used to display information displayed by software operating on the computer (101), for example, a computer program in accordance with the embodiment of the present invention operating, data filtering-processed in accordance with the embodiment of the present invention and data obtained by performing statistical processing of the filtering-processed data by an appropriate graphical interface.

A disk (108), for example, a hard disk or a solid state drive can be arbitrarily connected to the bus (104), for example, via a SATA or IDE controller (107).

The disk (108) and a drive (109), for example, a CD, DVD or BD drive can be arbitrarily connected to the bus (104), for example, via the SATA or IDE controller (107).

A keyboard (111) and a mouse (112) can be arbitrarily connected to the bus (104) via a peripheral device controller (110), for example, a keyboard/mouse controller or a USB bus.

An operating system, such as Windows® OS, UNIX® and MacOS®, Java® processing environment such as J2EE, Java® applications, Java® Virtual Machine (VM), a program providing Java® Just-in-Time (JIT) Compiler, the computer program in accordance with the embodiment of the present invention and other programs, and data can be stored in the disk (108) in a manner that they can be loaded to the main memory (103).

The disk (108) may be internally included in the computer (101), may be connected via a cable so that the computer (101) can access it, or may be connected via a wired or wireless network so that the computer (101) can access it.

The drive (109) can be used to install a program, for example, an operating system or an application into the disk (108) from a CD-ROM, a DVD-ROM or a BD as necessary.

A communication interface (114) is in accordance with, for example, the Ethernet® protocol. The communication interface (114) is connected to the bus (104) via a communication controller (113). The communication interface (114) plays a role of wiredly or wirelessly connecting the computer (101) to a communication line (115) and provides a network interface layer for the TCP/IP communication protocol for the communication functions of the operating system of the computer (101). The communication line can be, for example, a wired LAN environment based on a wired LAN connection standard or a wireless LAN environment based on a wireless LAN connection standard, for example, a Wi-Fi wireless LAN environment such as IEEE802.11a/b/g/n or a mobile phone network environment (for example, a 3G or 4G (including LTE) environment).

The computer (101) can receive data from a mobile body via the communication line (115) and store the data into the disk (108).

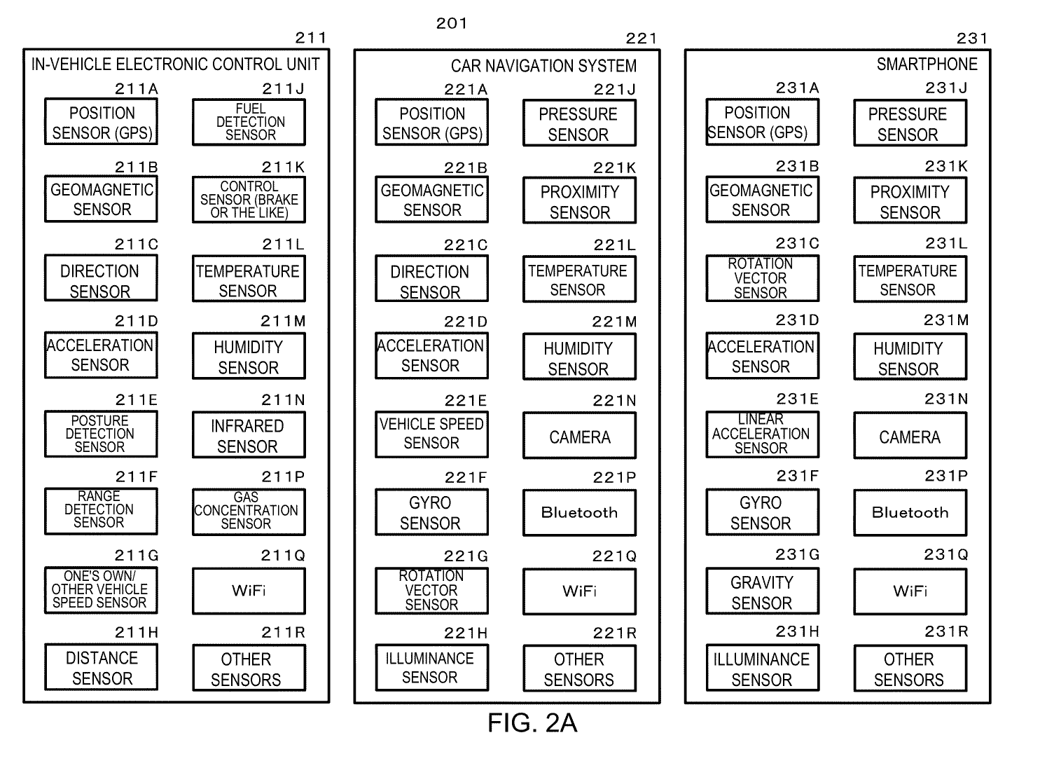

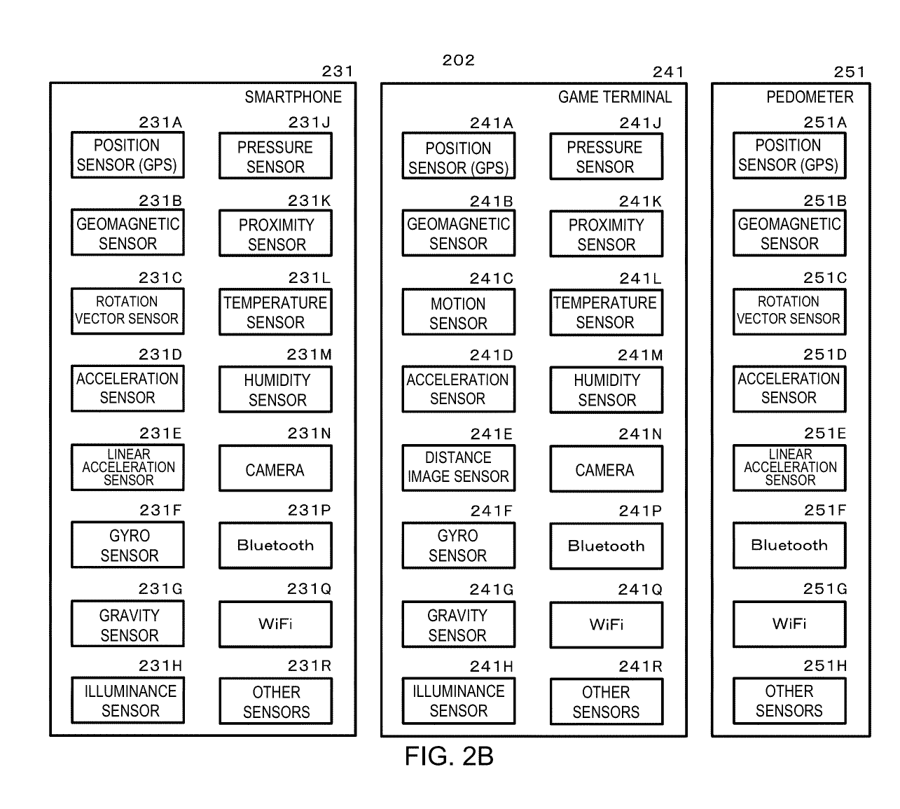

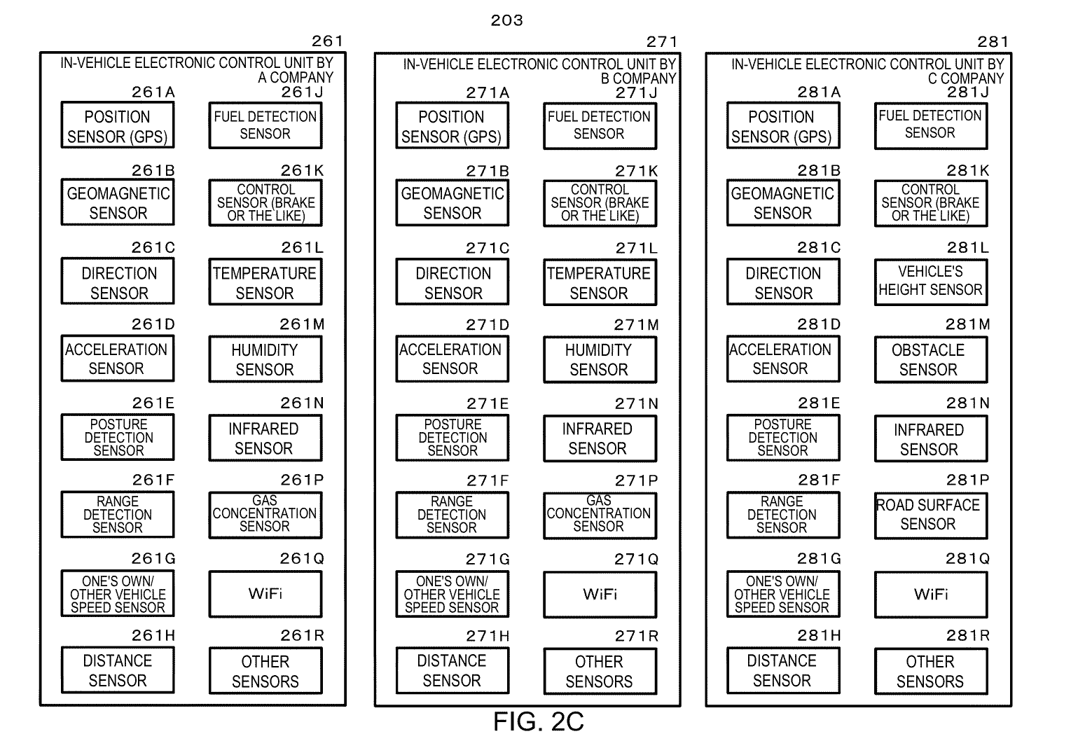

FIGS. 2A, 2B and 2C show examples of various kinds of mobile bodies which can be used in the embodiment of the present invention and sensors provided in each of the various mobile bodies.

FIG. 2A is a diagram showing the various kinds of mobile bodies which can be used in the embodiment of the present invention and the sensors provided in each of the various kinds of mobile bodies.

FIG. 2A shows an in-vehicle electronic control unit (hereinafter also referred to as an “ECU”) (211) provided in one car (201), a portable car navigation system (hereinafter also referred to as a “car navigator”) (221) mounted later on the car (201), and a smartphone (231) the driver of the car (201) holds in his/her pocket.

In the example of FIG. 2A, when the car (201) starts to move, all of the ECU (211), the car navigator (221) and the smartphone (231) move accompanying the car (201). Therefore, all of the ECU (211), the car navigator (221) and the smartphone (231) are the “mobile bodies” stated in the present invention.

The ECU (211) is provided with a position sensor (211A), a geomagnetic sensor (211B), a direction sensor (211C), an acceleration sensor (211D), a posture detection sensor (211E), a range detection sensor (211F), a one's own/other vehicle speed sensor (211G), a distance sensor (211H), a fuel detection sensor (211J), a control sensor (211K), a temperature sensor (211L), a humidity sensor (211M), an infrared sensor (211N), a gas concentration sensor (211P), Wi-Fi (211Q), and one or multiple other arbitrary sensors (211R).

The car navigator (221) is provided with a position sensor (221A), a geomagnetic sensor (221B), a direction sensor (221C), an acceleration sensor (221D), a vehicle speed sensor (221E), a gyro sensor (221F), a rotation vector sensor (221G), an illuminance sensor (221H), a pressure sensor (221J), a proximity sensor (221K), a temperature sensor (221L), a humidity sensor (221M), a camera (221N), Bluetooth® (221P), Wi-Fi (221Q), and one or multiple other arbitrary sensors (221R).

The smartphone (231) is provided with a position sensor (231A), a geomagnetic sensor (231B), a rotation vector sensor (231C), an acceleration sensor (231D), a linear acceleration sensor (231E), a gyro sensor (231F), a gravity sensor (231G), an illuminance sensor (231H), a pressure sensor (231J), a proximity sensor (231K), a temperature sensor (231L), a humidity sensor (231M), a camera (231N), Bluetooth® (231P), Wi-Fi (231Q), and one or multiple other arbitrary sensors (231R).

Each of the ECU (211), the car navigator (221) and the smartphone (231) has sensors (the position sensor, the geomagnetic sensor, the acceleration sensor, the temperature sensor, the humidity sensor and Wi-Fi) measuring data of the same target among them. Therefore, pieces of data which the server (101) can acquire from the ECU (211), the car navigator (221) and the smartphone (231), respectively, are pieces of data acquired from almost the same position even if the car (201) is moving. However, data from each of the sensors of the ECU (211), the car navigator (221) and the smartphone (231) measuring the data of the same target may differ, for example, in precision, accuracy or measurement intervals according to the kind or year of manufacture of the sensor.

Similarly, for example, each of the car navigator (221) and the smartphone (231) has sensors (the position sensor, the geomagnetic sensor, the acceleration sensor, the gyro sensor, the illuminance sensor, the pressure sensor, the proximity sensor, the temperature sensor, the humidity sensor, the camera, Bluetooth® and Wi-Fi) measuring the data of the same target between them. Therefore, pieces of data which the server (101) can acquire from the car navigator (221) and the smartphone (231), respectively, are pieces of data acquired from almost the same position even if the car (201) is moving. However, data from each of the sensors of the car navigator (221) and the smartphone (231) measuring the data of the same target may differ, for example, in the precision, accuracy or measurement intervals according to the kind or year of manufacture of the sensor.

As described above, though the server (101) acquires pieces of data of the same target from the multiple sensors, respectively, at almost the same position even if the car (201) is moving, the pieces of data may overlap or may differ in the precision, accuracy or measurement intervals.

FIG. 2B is a diagram showing the various kinds of mobile bodies which can be used in the embodiment of the present invention and the sensors provided in each of the various kinds of mobile bodies.

In the example of FIG. 2B, it is assumed that the driver of the car (201) stated with reference to FIG. 2A gets out of the car (201) carrying the smartphone (231) and walks away further carrying a game terminal (241) and a pedometer (251). Therefore, all of the smartphone (231), the game terminal (241) and the pedometer (251) move accompanying the driver. Therefore, all of the smartphone (231), the game terminal (241) and the pedometer (251) are the “mobile bodies” stated in the present invention.

The smartphone (231) is provided with the various kinds of sensors (231A to 231R) as stated in the description of FIG. 2A.

The game terminal (241) is provided with a position sensor (241A), a geomagnetic sensor (241B), a motion sensor (241C), an acceleration sensor (241D), a distance image sensor (241E), a gyro sensor (241F), a gravity sensor (241G), an illuminance sensor (241H), a pressure sensor (241J), a proximity sensor (241K), a temperature sensor (241L), a humidity sensor (241M), a camera (241N), Bluetooth® (241P), Wi-Fi (241Q), and one or multiple other arbitrary sensors (241R).

The pedometer (251) is provided with a position sensor (251A), a geomagnetic sensor (251B), a rotation vector sensor (251C), an acceleration sensor (251D), a linear acceleration sensor (251E), Bluetooth® (251F), Wi-Fi (251G), and one or multiple other arbitrary sensors (251H).

Each of the smartphone (231), the game terminal (241) and the pedometer (251) has sensors (the position sensor, the geomagnetic sensor, the acceleration sensor, Bluetooth® and Wi-Fi) measuring data of the same target among them. Therefore, pieces of data which the server (101) can acquire from the smartphone (231), the game terminal (241) and the pedometer (251), respectively, are pieces of data acquired from almost the same position even if the driver is moving. However, data from each of the sensors of the smartphone (231), the game terminal (241) and the pedometer (251) measuring the data of the same target may differ, for example, in the precision, accuracy or measurement intervals according to the kind or year of manufacture of the sensor.

Similarly, for example, each of the game terminal (241) and the pedometer (251) has sensors (the position sensor, the geomagnetic sensor, the acceleration sensor, Bluetooth® and Wi-Fi) measuring data of the same target between them. Therefore, pieces of data which the server (101) can acquire from the game terminal (241) and the pedometer (251), respectively, are pieces of data acquired from almost the same position even if the driver is moving. However, data from each of the sensors of the game terminal (241) and the pedometer (251) measuring the data of the same target may differ, for example, in the precision, accuracy or measurement intervals according to the kind or year of manufacture of the sensor.

As described above, though the server (101) acquires pieces of data of the same target from the multiple sensors, respectively, at almost the same position even if the driver is moving, the pieces of data may overlap or may differ in the precision, accuracy or measurement intervals.

FIG. 2C is a diagram showing the various kinds of mobile bodies which can be used in the embodiment of the present invention and the sensors provided in each of the various kinds of mobile bodies.

In the example of FIG. 2C, it is assumed that a car A mounted with an ECU (261) by A Company, a car B mounted with an ECU (271) by B Company and a car C mounted with an ECU (281) by C Company are traveling close to one another on the same road in a line or side by side.

When each of the cars A, B and C starts to move, all of the ECU (261), the ECU (271) and the ECU (281) move accompanying the car A, the car B and the car C, respectively. Therefore, all of the ECU (261), the ECU (271) and the ECU (281) are the “mobile bodies” stated in the present invention.

The ECU (261) by A Company is provided with a position sensor (261A), a geomagnetic sensor (261B), a direction sensor (261C), an acceleration sensor (261D), a posture detection sensor (261E), a range detection sensor (261F), a one's own/other vehicle speed sensor (261G), a distance sensor (261H), a fuel detection sensor (261J), a control sensor (261K), a temperature sensor (261L), a humidity sensor (261M), an infrared sensor (261N), a gas concentration sensor (261P), Wi-Fi (261Q), and one or multiple other arbitrary sensors (261R).

The ECU (271) by B Company is provided with a position sensor (271A), a geomagnetic sensor (271B), a direction sensor (271C), an acceleration sensor (271D), a posture detection sensor (271E), a range detection sensor (271F), a one's own/other vehicle speed sensor (271G), a distance sensor (271H), a fuel detection sensor (271J), a control sensor (271K), a temperature sensor (271L), a humidity sensor (271M), an infrared sensor (271N), a gas concentration sensor (271P), Wi-Fi (271Q), and one or multiple other arbitrary sensors (271R).

The ECU (281) by C Company is provided with a position sensor (281A), a geomagnetic sensor (281B), a direction sensor (281C), an acceleration sensor (281D), a posture detection sensor (281E), a range detection sensor (281F), a one's own/other vehicle speed sensor (281G), a distance sensor (281H), a fuel detection sensor (281J), a control sensor (281K), a vehicle's height sensor (281L), an obstacle sensor (281M), an infrared sensor (281N), a road surface sensor (281P), Wi-Fi (281Q), and one or multiple other arbitrary sensors (281R).

Each of the ECU (261) by A Company, the ECU (271) by B Company and the ECU (281) by C Company has sensors (the position sensor, the geomagnetic sensor, the direction sensor, the acceleration sensor, the posture detection sensor, the range detection sensor, the one's own/other vehicle speed sensor, the distance sensor, the fuel detection sensor, the control sensor, the infrared sensor and Wi-Fi) measuring data of the same target among them. Therefore, since the cars A, B and C are traveling on the same road in a line or side by side, being close to one another, pieces of data which the server (101) can acquire from the ECU (261) by A Company, the ECU (271) by B Company and the ECU (281) by C Company, respectively, are pieces of data acquired from almost the same position even if each of the cars A, B and C is moving. However, data from each of the sensors of the ECU (261) by A Company, the ECU (271) by B Company and the ECU (281) by C Company measuring the data of the same target may differ, for example, in the precision, accuracy or measurement intervals, for example, due to difference in default settings of the car manufacture.

As described above, though the server (101) acquires pieces of data of the same target from the multiple sensors, respectively, at almost the same position even if the driver is moving, the pieces of data may overlap or may differ in the precision, accuracy or measurement intervals.

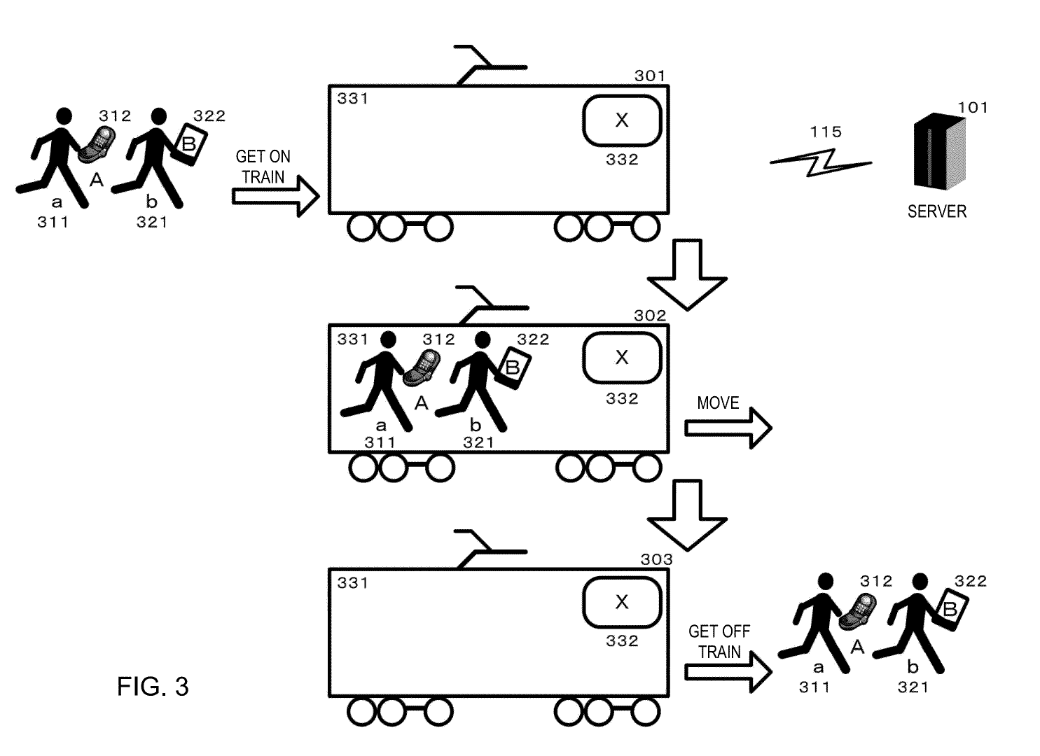

FIGS. 3, 4 and 5 show specific examples of providing various kinds of solutions, respectively, by dynamically associating mobile bodies, aggregating data from the associated mobile bodies and performing filtering processing, in accordance with the embodiment of the present invention.

FIG. 3 is a diagram showing, for a solution for following persons' movements in a city, a scenario of aggregating data from mobile bodies related to the persons and performing filtering processing, in accordance with the embodiment of the present invention.

Mobile bodies used in the scenario of FIG. 3 are as shown below.
Mobile bodies are terminals which individuals have, respectively. A person a (311) has a terminal A (312) (for example, a mobile phone), and a person b (321) has a terminal B (322) (for example, a smartphone). Both of the terminal A (312) and the terminal B (322) can move accompanying the person a (311) and the person b (321), respectively. Therefore, both of the terminal A (312) and the terminal B (322) are the “mobile bodies” stated in the present invention.
A mobile body is a sensor X (332) mounted on a train (331) which is a public mobile body. The sensor X (332) can move accompanying the train (331). Therefore, the sensor X (332) is the “mobile body” stated in the present invention.

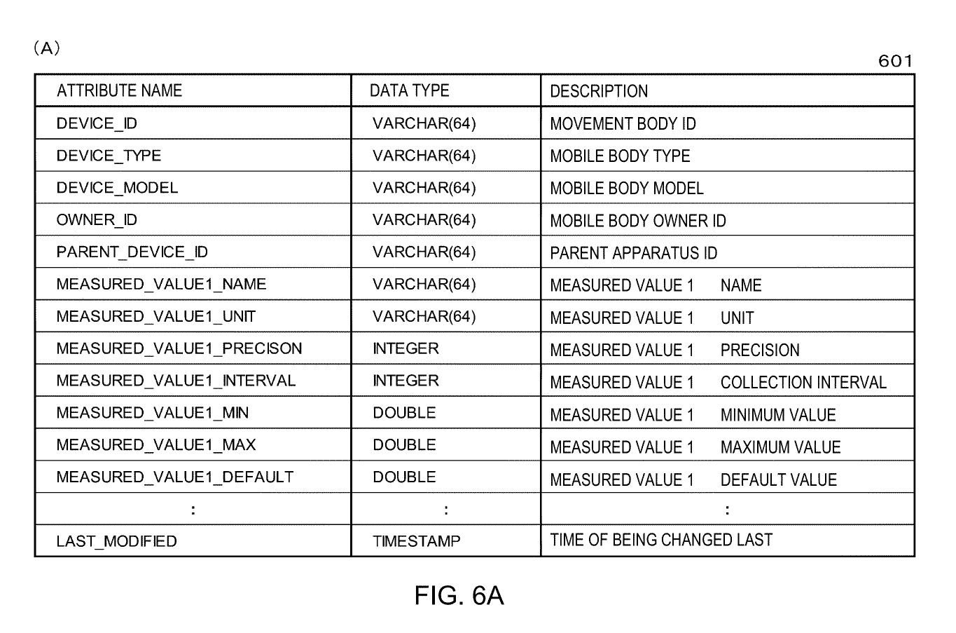

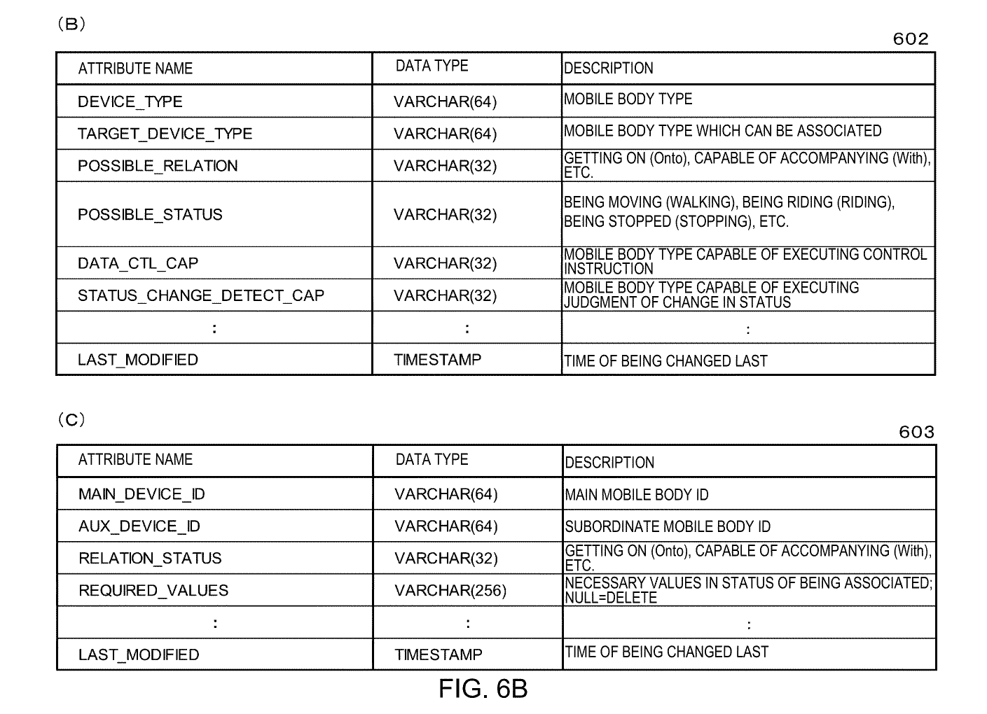

Information about each mobile body used in the scenario of FIG. 3 is as shown below. For example, the information can be implemented as a mobile bodies' relations database shown in FIGS. 6A and 6B described below. However, the information may be managed in a method in accordance with any other data management fashion.

Both of the mobile body types of the terminal A (312) and the terminal B (322) are “capable of being mounted on a train” and “capable of measuring data with a predetermined precision or at predetermined intervals”.

The mobile body type of the terminal A (312) is “not capable of giving an instruction for controlling data transmission” (data transmission control instruction=No) on the terminal side and “not capable of identifying change in the status” of the terminal (status change identification=No) on the terminal side.

The mobile body type of the terminal B (322) is “capable of giving an instruction for controlling data transmission” (data transmission control instruction=Yes) on the terminal side and “capable of identifying change in the status” of the terminal (status change identification=Yes) on the terminal side.

The mobile body type of the sensor X (332) is “mounted on a train”, “capable of being mounted (associated) with a mobile phone or a smartphone”, and “measuring data with a predetermined precision or at predetermined intervals”.

The precision of data collected by the sensor X (332) is assumed to be the same as or higher than the precision of data collected by each of the sensors provided in each of the terminal A (312) and the terminal B (322).

In the scenario of FIG. 3, neither the person a (311) nor the person b (321) has not got on the train (331) yet (301). In that case, initial information about each mobile body is as shown below.
Terminal A (312): mobile body type=mobile phone; owner=person a (311); history of mounting (association) in the past=sensor X (332); association of mobile body=none
Terminal B (322): mobile body type=smartphone; owner=person b (321); history of mounting (association) in the past=none; association of mobile body=none
Sensor X (332): mobile body type=train; history of mounting (association) in the past=terminal A (312); association of mobile body=none

The server (101) receives data from each of the terminal A (312) and the terminal B (322), and from the sensor X (332) mounted on the train (331). The data can include, for example, position, movement direction, speed, acceleration and/or time.

On the basis of data from the sensor X (332), the server (101) calculates the movement vector of the train (331) (that is, a movement vector equal to the movement vector of the sensor X (332)). Furthermore, the server (101) similarly calculates the movement vectors of the terminal A (312) and the terminal B (322) on the basis of data from the terminal A (312) and data from the terminal B (322), respectively.

It is assumed that the person a (311) and the person b (321) have got on the train (331) (302).

The server (101) judges a mobile body corresponding to or almost corresponding to the movement vector of the sensor X (332), among mobile body types capable of being mounted on (that is, capable of being associated with) the sensor X (332) (mobile body type=train), on the basis of the data received from each of the mobile bodies, at predetermined time intervals.

The server (101) detects that, in addition to the terminal A (312) and the terminal B (322), the movement vectors of a lot of mobile bodies existing in the train (331) correspond to or almost correspond to the movement vector of the sensor X (332).

The server (101) can make it possible to preferentially detect whether the current movement vector of the terminal A (312) corresponds to or almost corresponds to the current movement vector of the train (331), prior to the other mobile bodies, from history of mounting (association) in the past (history of mounting (association) in the past=sensor X (332)).

Because the mobile body type of the terminal A (312) is “not capable of identifying change in the status” (status change identification=No) on the terminal side, the terminal A (312) itself cannot detect that it has got on the train (331). On the other hand, because the mobile body type of the terminal B (322) is “capable of identifying change in the status” (status change identification=Yes) on the terminal side, the terminal B (322) can transmit information to the effect that it has got on the train (331) to the server (101). The server (101) can make it possible to preferentially detect whether the current movement vector of the terminal B (322) corresponds to or almost corresponds to the current movement vector of the sensor X (332) immediately or prior to the other mobile bodies, in response to receiving the information to the effect that the terminal B (322) has got on the train (331) from the terminal B (322).

The server (101) judges that the sensor X (332) can be associated with the terminal A (312) and the terminal B (322). Then, in response to associating the sensor X (332) with each of the terminal A (312) and the terminal B (322), the server (101) adds information indicating that the sensor X (332) has been associated with each of the terminal A (312) and the terminal B (322), for example, the information shown below into, for example, a mobile bodies' relations database (603) shown in FIG. 6C described below. The information about being associated is, for example, as shown below.
Terminal A (312): mounted on (associated with) sensor X (332)
Terminal B (322): mounted on (associated with) sensor X (332)
Sensor X (332): mounted (associated) with terminal A (312); mounted (associated) with terminal B (322)

Since data collected from each of the terminal A (312) and the terminal B (322) has the same precision as data collected from the sensor X (332), the server (101) judges that the data collected from the sensor X (332) can substitute. Alternatively, since the precision of the data collected from the sensor X (332) is higher than the precision of the data collected from each of the terminal A (312) and the terminal B (322), the server (101) judges that the data collected from each of the terminal A (312) and the terminal B (322) can be replaced with the data collected from the sensor X (332).

Since the mobile body type of the terminal A (312) is “not capable of giving an instruction for controlling data transmission” of the terminal (data transmission control instruction=No) on the terminal side, the server (101) performs filtering processing of the data from the terminal A (312) on the server (101) side. That is, the server (101) deletes the data from the terminal A (312) on the server (101) side.

On the other hand, since the mobile body type of the terminal B (322) is “capable of giving an instruction for controlling data transmission” of the terminal (data transmission control instruction=Yes) on the terminal side, the server (101) transmits a control instruction instructing the terminal B (322) not to transmit data (that is, to delete data on the terminal B (322) side), to the terminal B (322).

Furthermore, the server (101) can add information about the content of the data filtering processing, for example, the information shown below into the information about being associated.
Terminal A (312): mounted on (associated with) sensor X (332); data is to be deleted on the server (101) side
Terminal B (322): mounted on (associated with) sensor X (332); data is to be deleted on the terminal B (322) side
Sensor X (332): mounted (associated) with terminal A (312); mounted (associated) with terminal B (322)

Furthermore, the server (101) can add the following history information to the effect that the terminal A (312) and the terminal B (322) have been mounted on the train (331), into the information about being associated.
Terminal A (312): mounted on sensor X (332); data is to be deleted on server (101) side; mounted on train (331) (or mounted on train (331) together with terminal B (322)); time of being mounted on train (331)
Terminal B (322): mounted on (associated with) sensor X (332); data is to be deleted on terminal B (322) side; mounted on train (331) (or mounted on train (331) together with terminal A (312)); time of being mounted on train (331)
Sensor X (332): mounted (associated) with terminal A (312); mounted (associated) with terminal B (322); time of being mounted (associated) with terminal A (312); time of being mounted (associated) with terminal B (322)

While association between the sensor X (332) and each of the terminal A (312) and the terminal B (322) is continued, data from the terminal A (312) is filtered by the server (101), and data from the terminal B (322) is filtered (that is, deleted) by the terminal B (322).

Thus, since data transmission from the terminal B (322) to the server (101) is not performed, the amount of data on the network infrastructure can be reduced.

Furthermore, a succeeding application operating on the server (101) or another server (not shown) different from the server (101) can know where to acquire necessary data, from the history of mobile body mounting (association). The succeeding application can be an application for visualizing the flow of people on a map or an application for aggregating the number of people moving at a certain time point for each area and displaying the result as a graph.

The server (101) can periodically judge whether the association between the sensor X (332) and each of the terminal A (312) and the terminal B (322) can be continued (in other words, whether the association is to be canceled). For this judgment, the server (101) can periodically confirm whether the movement vector of the sensor X (332) corresponds to each of the movement vectors of the terminal A (312) and the terminal B (322). Furthermore, the server (101) can presume a possibility of the person a (311) or the person b (321) getting off the train (331) within a stoppage time of the train (331) at each station where the train (331) stops (for example, the stoppage time at the stoppage station described in a timetable, an estimated stoppage time at the stoppage station based on an actual operation state of the train (331) or a stoppage time at the stoppage station based on the past operation history of the train (331)), and judge whether the association can be continued after elapse of the above stoppage time.

Because the terminal A (312) itself cannot judge that the terminal A (312) has got off the train (331) (status change identification=No), the server (101) judges whether the terminal A (312) (that is, the person a (311)) has got off the train (331). Because the terminal A (312) cannot perform filtering processing (data transmission control instruction=No) on the terminal A (312) side, the terminal A (312) continuously transmits data from the terminal A (312) to the server (101). The server (101) judges whether or not to cancel the association between the terminal A (312) and the sensor X (332) on the basis of the data transmitted from the terminal A (312). For example, in response to the terminal A (312) having got off the train (331) (303), the server (101) judges that the association between the terminal A (312) and the sensor X (332) is to be canceled. In response to the association between the terminal A (312) and the sensor X (332) being to be canceled (303), the server (101) stops filtering processing of the data from the terminal A (312) and stores the data from the terminal A (312) into the storage medium (108) of the server (101).

Because the terminal B (322) itself can judge that the terminal B (322) has got off the train (331) (303) (status change identification=Yes), the terminal B (322) itself judges whether the terminal B (322) (that is, the person b (321)) has got off the train (331). The terminal B (322) judges whether the terminal B (322) has got off the train (331), for example, by identifying change in the status by a value of the acceleration sensor. Because the terminal B (322) and the train (331) does not have the same or almost the same movement vectors any more (that is, the requirement for being able to be associated is not satisfied any more) in response to the terminal B (322) having got off the train (331), the terminal B (322) transmits a relation cancellation notification to the server (101). In response to receiving the relation cancellation notification from the terminal B (322), the server (101) transmits a control instruction instructing the terminal B (322) to transmit data, to the terminal B (322). In response to receiving the control instruction, the terminal B (322) resumes transmission of data to the server (101).

In response to the association between the sensor X (332) and each of the terminal A (312) and the terminal B (322) having been canceled, the server (101) changes the information about being associated, for example, as shown below.
Terminal A (312): time of getting off train (331) (date and time when association with sensor X (332) ends); history of mounting (association) in the past=sensor X (332)
Terminal B (322): time of getting off train (331) (date and time when association with sensor X (332) ends); history of mounting (association) in the past=sensor X (332)
Sensor X (332): time of terminal A (312) getting off train (331) (date and time when association with terminal A (312) ends); time of terminal B (322) getting off train (331) (date and time when association with terminal B (322) ends)

The server (101) can change the above-described initial information of each mobile body as shown below.
Terminal A (312): mobile body type=mobile phone; owner=person a (311); history of mounting (association) in the past=sensor X (332); association of mobile body=none
Terminal B (322): mobile body type=smartphone; owner=person b (321); history of mounting (association) in the past=sensor X (332); association of mobile body=none
Sensor X (332): mobile body type=train; history of mounting (association) in the past=terminal A (312); history of mounting (association) in the past=terminal B (322); association of mobile body=none

An example of dynamically judging association and cancellation of the association while collecting data from each of the terminals A and B (312 and 322), and performing filtering processing has been shown above. As another implementation method in accordance with the present invention, it is also possible to collect all of data from each of the terminals A and B (312 and 322) into the server (101) once and then perform filtering processing of at least a part of the data.

By using the embodiment described above, it becomes possible for the server (101) to follow a person's movement using data from a mobile terminal (for example, a smartphone or a mobile phone) the person carries. Therefore, in the case of following persons' movements in a city as described above, using data from terminals the persons carry or from vehicles, it becomes possible to reduce the load on a network and the amount of data transmission, or the load on storage and succeeding data processing and enhance the precision of values measured by the sensors and used for succeeding data processing.

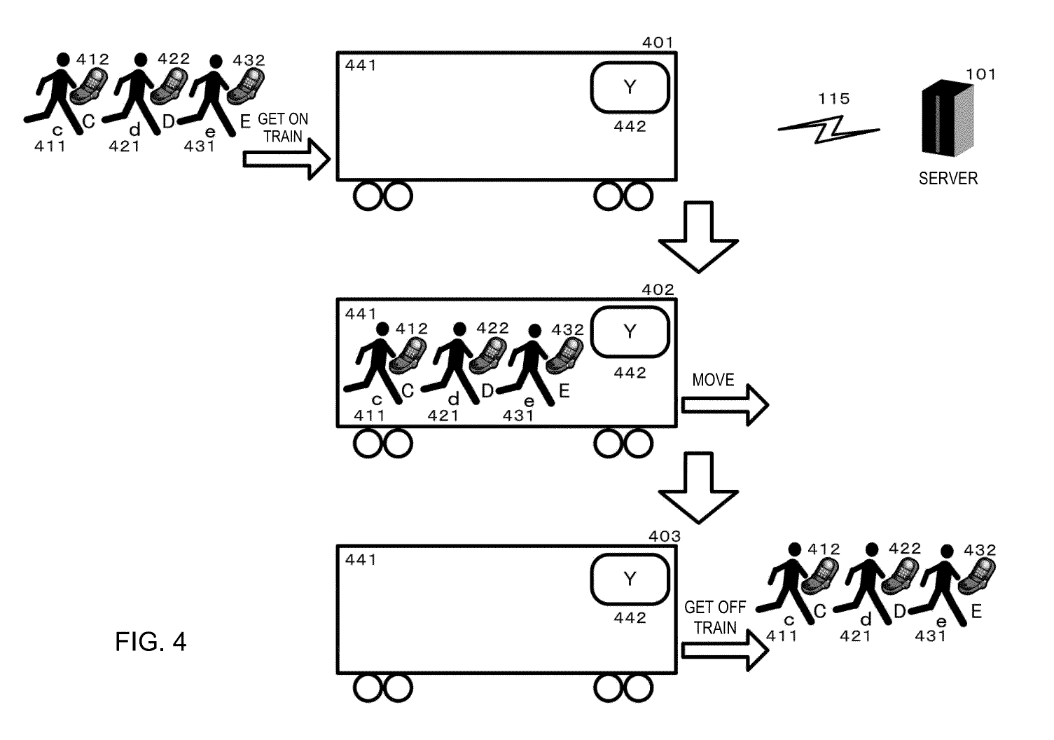

FIG. 4 is a diagram showing, for a solution for performing traffic jam management or advertisement distribution, a scenario of aggregating data from mobile bodies related to cars and performing filtering processing, in accordance with the embodiment of the present invention.

Mobile bodies used in the scenario of FIG. 4 are as shown below.
Mobile bodies are terminals which individuals have, respectively. A person c (411) has a terminal C (412) (for example, a mobile phone by C Company); a person d (421) has a terminal D (422) (for example, a mobile phone by D Company); and a person e (431) has a terminal E (432) (for example, a mobile phone by E Company). All of the terminal C (412), the terminal D (422) and the terminal E (432) can move accompanying the person c (411), the person d (421) and the person e (431), respectively. Therefore, all of the terminal C (412), the terminal D (422) and the terminal E (432) are the “mobile bodies” stated in the present invention.
A mobile body is a sensor Y (442) mounted on a car (441). The sensor Y (442) can move accompanying the car (441). Therefore, the sensor Y (442) is the “mobile body” stated in the present invention.

Information about each mobile body used in the scenario of FIG. 4 is as shown below. For example, the information can be implemented as a mobile bodies' relations database shown in FIGS. 6A and 6B described below. However, the information may be managed in a method in accordance with any other data management fashion.

All of the mobile types of the terminal C (412), the terminal D (422) and the terminal E (432) are “capable of being mounted on a car” and “capable of measuring data with a predetermined precision or at predetermined intervals”.

The mobile body type of the terminal C (412) is “capable of giving an instruction for controlling data transmission” (data transmission control instruction=Yes) on the terminal side and “not capable of identifying change in the status” of the terminal (status change identification=No) on the terminal side.

The mobile body type of the terminal D (422) is “capable of giving an instruction for controlling data transmission” (data transmission control instruction=Yes) on the terminal side and “capable of identifying change in the status” of the terminal (status change identification=Yes) on the terminal side.

The mobile body type of the terminal E (432) is “not capable of giving an instruction for controlling data transmission” (data transmission control instruction=No) on the terminal side and “not capable of identifying change in the status” of the terminal (status change identification=No) on the terminal side.

The mobile body type of the sensor Y (442) is “car”, “mounted on a car”, “capable of being mounted (associated) with a mobile phone and a smartphone”, and “measuring data with a predetermined precision or at predetermined intervals”.

It is assumed that the precision of data collected by each of sensors provided in each of the terminal C (412), the terminal D (422) and the terminal E (432) is different from the precision of data collected by the sensor Y (442).

In the scenario of FIG. 4, none of the person c (411), the person d (421) and the person e (431) has got on the car (441) yet (401). Initial information about each mobile body in that case is as shown below.
Terminal C (412): mobile body type=mobile phone; owner=person c (411); history of mounting (association) in the past=none; association of mobile body=none
Terminal D (422): mobile body type=mobile phone; owner=person d (421); history of mounting (association) in the past=sensor Y (442); association of mobile body=none
Terminal E (432): mobile body type=mobile phone; owner=person e (431); history of mounting (association) in the past=none; association of mobile body=none
Sensor Y (442): mobile body type=car (441); owner=person c (411); history of mounting (association) in the past=terminal D (422); association of mobile body=none

The server (101) receives data from each of the terminal C (412), the terminal D (422) and the terminal E (432), and from the sensor Y (442) mounted on the car (441). The data can include, for example, position, movement direction, speed, acceleration and/or time.

On the basis of data from the sensor Y (442), the server (101) calculates the movement vector of the car (441) (that is, a movement vector equal to the movement vector of the sensor Y (442)). Furthermore, the server (101) similarly calculates the movement vectors of the terminal C (412), the terminal D (422) and the terminal E (432) on the basis of data from the terminal C (412), the terminal D (422) and the terminal E (432), respectively.

It is assumed that the person c (411), the person d (421) and the person e (431) have got on the car (441) (402).

The server (101) judges a mobile body corresponding to or almost corresponding to the movement vector of the sensor Y (442) among mobile body types capable of being mounted on (that is, capable of being associated with) the sensor Y (442) (mobile body type=car), on the basis of the data received from each of the mobile bodies, at predetermined time intervals.

The server (101) detects that the movement vectors of the terminal C (412), the terminal D (422) and the terminal E (432) correspond to or almost correspond to the movement vector of the sensor Y (442). Since both of the owner of the terminal C (412) and the owner of the car (441) are the person c (411), the server (101) can make it possible to preferentially detect whether the current movement vector of the terminal C (412) corresponds to or almost corresponds to the current movement vector of the car (441), prior to the other mobile bodies. Furthermore, the server (101) can make it possible to preferentially detect whether the current movement vector of the terminal D (422) corresponds to or almost corresponds to the current movement vector of the car (441), prior to the other mobile bodies, from history of mounting (association) in the past (history of mounting (association) in the past=sensor Y (442)).

Because the mobile body type of the terminal C (412) is “capable of identifying change in the status” (status change identification=Yes) on the terminal side, the terminal C (412) can transmit information to the effect that it has got on the car (441) to the server (101). The server (101) can make it possible to preferentially detect whether the current movement vector of the terminal C (412) corresponds to or almost corresponds to the current movement vector of the sensor Y (442) immediately or prior to the other mobile bodies, in response to receiving the information to the effect that the terminal C (412) has got on the car (441) from the terminal C (412). Similarly, because the mobile body type of the terminal D (422) is “capable of identifying change in the status” (status change identification=Yes) on the terminal side, the terminal D (422) can transmit information to the effect that it has got on the car (441), to the server (101). The server (101) can make it possible to preferentially detect whether the current movement vector of the terminal D (422) corresponds to or almost corresponds to the current movement vector of the sensor Y (442) immediately or prior to the other mobile bodies, in response to receiving the information to the effect that the terminal D (422) has got on the car (441) from the terminal D (422). On the other hand, because the mobile body type of the terminal E (432) is “not capable of identifying change in the status” (status change identification=No) on the terminal side, the terminal E (432) itself cannot detect that it has got on the car (441).

The server (101) judges that the sensor Y (442) can be associated with the terminal C (412), the terminal D (422) and the terminal E (432). Then, in response to associating the sensor Y (442) with each of the terminal C (412), the terminal D (422) and the terminal E (432), the server (101) adds information indicating that the sensor Y (442) has been associated with each of the terminal C (412), the terminal D (422) and the terminal E (432), for example, the information below into, for example, the mobile bodies' relations database (603) shown in FIG. 6C described below. The information about being associated is, for example, as shown below.
Terminal C (412): mounted on (associated with) sensor Y (442)
Terminal D (422): mounted on (associated with) sensor Y (442)
Terminal E (432): mounted on (associated with) sensor Y (442)
Sensor Y (442): mounted (associated) with terminal C (412); mounted (associated) with terminal D (422); mounted (associated) with terminal E (432)

Data collected by each of the sensors of the terminal C (412), the terminal D (422) and the terminal E (432) may be replaced with data collected by the sensor Y (442), or the precision of the data collected by each sensor may be higher than the precision of the data collected by the sensor Y (442). Therefore, it is necessary for the server (101) to judge, for each piece of data, how and for which data from which sensor, among the sensors of the terminal C (412), the terminal D (422) and the terminal E (432), filtering processing is to be performed.

It is assumed that the precision of data from the terminal C (412) is similar to the precision of data from the sensor Y (442). Therefore, the data from the terminal C (412) can be replaced with the data from the sensor Y (442). Furthermore, it is possible to give a data transmission control instruction (data transmission control instruction=Yes) on the terminal C (412) side. Therefore, the server (101) transmits a control instruction instructing the terminal C (412) not to transmit data (that is, to delete data on the terminal C (412) side), to the terminal C (412).

It is assumed that data from the terminal D (422) includes acceleration data which the sensor Y (442) cannot measure, and that the precision of GPS data from the terminal D (422) is higher than the precision of GPS data from the sensor Y (442). Therefore, by supplementing the data from the sensor Y (442) with the acceleration data from the terminal D (422) and further replacing the GPS data with the GPS data from the terminal D (422), more useful data can be obtained. Furthermore, it is possible to give a data transmission control instruction (data transmission control instruction=Yes) on the terminal D (422) side. Therefore, the server (101) transmits a control instruction instructing the terminal D (422) to transmit only the acceleration and GPS data to the server (101) and not to transmit remaining data (that is, to delete the remaining data on the terminal D (422) side), to the terminal D (422). The server (101) can supplement the data from the sensor Y (442) with the acceleration data from the terminal D (422) and further replace the GPS data with the GPS data from the terminal D (422).

It is assumed that data from the terminal E (432) can be transmitted even in a tunnel, while the data from the sensor Y (442) cannot be transmitted because communication is interrupted in a tunnel. It is not possible to give a data transmission control instruction (data transmission control instruction=No) on the terminal E (432) side. Therefore, the server (101) uses the data from the terminal E (432) only when the data from the sensor Y (442) is insufficient. That is, the server (101) supplements the lost part of the data from the sensor Y (442) with a part of the data from the terminal E (432) and deletes the remaining data from the terminal E (432) which has not been used for the supplementation.

Furthermore, the server (101) can add information about the content of the data filtering processing, for example, the information shown below into the information about being associated.
Terminal C (412): mounted on (associated with) sensor Y (442); data is to be deleted on terminal C (412) side
Terminal D (422): mounted on (associated with) sensor Y (442); transmits acceleration data; GPS data is to be supplemented or deleted by server (101); other data is to be deleted on terminal D (422) side
Terminal E (432): mounted on (associated with) sensor Y (442); data is to be supplemented or deleted by server (101)
Sensor Y (442): mounted (associated) with terminal C (412); mounted (associated) with terminal D (422); mounted (associated) with terminal E (432)

Furthermore, the server (101) can add the following history information to the effect that the terminal C (412), the terminal D (422) and the terminal E (432) have been mounted on the car (441), into the information about being associated.
Terminal C (412): mounted on (associated with) sensor Y (442); data is to be deleted on terminal C (412) side; time of being mounted on car (441)
Terminal D (422): mounted on (associated with) sensor Y (442); transmits acceleration data; GPS data is to be supplemented or deleted by server (101); other data is to be deleted on terminal D (422) side; time of being mounted on car (441)
Terminal E (432): mounted on (associated with) sensor Y (442); data is to be supplemented or deleted by server (101); time of being mounted on car (441)
Sensor Y (442): mounted (associated) with terminal C (412): mounted (associated) with terminal D (422); mounted (associated) with terminal E (432); time of being mounted (associated) with terminal C (412); time of being mounted (associated) with terminal D (422); time of being mounted (associated) with terminal E (432)

While association between the sensor Y (442) and each of the terminal C (412), the terminal D (422) and the terminal E (432) is continued, the data from the terminal C (412) is filtered (that is, deleted) by the terminal C (412); the data from the terminal D (422) other than the acceleration data and the GPS data is filtered (that is, deleted) by the terminal D (422); and the data which has not been used for supplementation of the lost part, among the data from the terminal E (432), is filtered (that is, deleted) by the server (101).

Thus, since data transmission from the terminal C (412) to the server (101) is not performed, the amount of data on the network infrastructure can be reduced.

Furthermore, since the data from the sensor Y (442) is supplemented by the data from the terminal D (422), it becomes possible to supplement data which the sensor Y (442) cannot measure, and collect data with a high precision and accuracy.

Furthermore, since the data from the sensor Y (442) is supplemented by the data from the terminal E (432), it becomes possible to supplement lost data.

The server (101) can periodically judge whether the association between the sensor Y (442) and each of the terminal C (412), the terminal D (422) and the terminal E (432) can be continued (in other words, whether the association is to be canceled). In order to perform the judgment, the server (101) can periodically confirm whether the movement vector of the sensor Y (442) and each of the movement vectors of the terminal C (412), the terminal D (422) and the terminal E (432) correspond to each other. Furthermore, if the car (441) is, for example, a bus providing a periodical transportation service, the server (101) presumes a possibility of the person c (411), the person d (421) or the person e (431) getting off the car (441) within a stoppage time at each bus stop (for example, a stoppage time at each bus stop described in a timetable at the bus stop, an estimated stoppage time at each bus stop based on an actual operation state of the car (441) or a stoppage time at each bus stop based on the driving history in the past of the car (441)) and judge whether the association can be continued after elapse of the above stoppage time.

It is assumed that the person c (411), the person d (421) and the person e (431) have got off the car (441) (403).

Because the terminal C (412) itself cannot judge that the terminal C (412) has got off the car (441) (status change identification=No), the server (101) judges whether the terminal C (412) (that is, the person c (411)) has got off the car (441). For this judgment, the server (101) can periodically performs polling to the terminal C (412) to cause the terminal C (412) to transmit data to the server (101). On the basis of data transmitted from the terminal C (412), the server (101) judges that the association between the terminal C (412) and the sensor Y (442) is to be canceled in response to the terminal C (412) having got off the car (441) (403). In response to the association between the terminal C (412) and the sensor Y (442) being to be canceled (403), the server (101) stops filtering processing of the data from the terminal C (412) and stores all the data from the terminal C (412) into the storage medium (108) of the server (101).

Because the terminal D (422) itself can judge that the terminal D (422) has got off the car (441) (403) (status change identification=Yes), the terminal D (422) itself judges whether the terminal D (422) (that is, the person d (421)) has got off the car (441). The terminal D (422) judges whether the terminal D (422) has got off the car (441), for example, by identifying change in the status by a value of the acceleration sensor. Because the terminal D (422) and the car (441) do not have the same or almost the same movement vector any more (that is, the requirement for being able to be associated is not satisfied any more) in response to the terminal D (422) having got off the car (441), the terminal D (422) transmits a relation cancellation notification to the server (101). In response to receiving the relation cancellation notification from the terminal D (422), the server (101) transmits a control instruction instructing the terminal D (422) to transmit all data, to the terminal D (422). In response to receiving the control instruction, the terminal D (422) resumes transmission of all the data to the server (101).

Because the terminal E (432) itself cannot judge that the terminal E (432) has got off the car (441) (status change identification=No), the server (101) judges whether the terminal E (432) (that is, the person e (431)) has got off the car (441). Because the terminal E (432) cannot perform filtering processing on the terminal E (432) side (data transmission control instruction=No), the terminal E (432) continuously transmits data from the terminal E (432) to the server (101). The server (101) judges whether or not to cancel the association between the terminal E (432) and the sensor Y (442) on the basis of the data transmitted from the terminal E (432). For example, in response to the terminal E (432) having got off the car (441) (403), the server (101) judges that association between the terminal E (432) and the sensor Y (442) is to be canceled. In response to the association between the terminal E (432) and the sensor Y (442) being to be canceled (403), the server (101) stops filtering processing of the data from the terminal E (432) and stores all the data from the terminal E (432) into the storage medium (108) of the server (101).

In response to the association between the sensor Y (442) and each of the terminal C (412), the terminal D (422) and the terminal E (432) having been canceled, the server (101) changes the information about being associated, for example, as shown below.
Terminal C (412): time of getting off car (441) (date and time when association with sensor Y (442) ends); history of mounting (association) in the past=sensor Y (442)
Terminal D (422): time of getting off car (441) (date and time when association with sensor Y (442) ends); history of mounting (association) in the past=sensor Y (442)
Terminal E (432): time of getting off car (441) (date and time when association with sensor Y (442) ends); history of mounting (association) in the past=sensor Y (442)
Sensor Y (442): time of terminal C (412) getting off car (441) (date and time when association with terminal C (412) ends); time of terminal D (422) getting off car (441) (date and time when association with terminal D (422) ends); time of terminal E (432) getting off car (441) (date and time when association with terminal E (432) ends)

The server (101) can change the above-described initial information of each mobile body as shown below.
Terminal C (412): mobile body type=mobile phone; owner=person c (411); history of mounting (association) in the past=sensor Y (442); association of mobile body=none
Terminal D (422): mobile body type=mobile phone; owner=person d (421); history of mounting (association) in the past=sensor Y (442); association of mobile body=none
Terminal E (432): mobile body type=mobile phone; owner=person e (431); history of mounting (association) in the past=sensor Y (442); association of mobile body=none
Sensor Y (442): mobile body type=car (441); owner=person c (411); association of mobile body=sensor Y (442); history of mounting (association) in the past=terminal C (412); history of mounting (association) in the past=terminal D (422); history of mounting (association) in the past=terminal E (432); association of mobile body=none

An example of dynamically judging association and cancellation of the association while collecting data from each of the terminals C, D and E (412, 422 and 432), and performing filtering processing has been shown above. As another implementation method in accordance with the present invention, it is also possible to collect all of data from each of the terminals C, D and E (412, 422 and 432) into the server (101) once and then perform filtering processing of at least a part of the data.

By utilizing the embodiment described above, it becomes possible for the server (101) to perform traffic jam management, for example, by replacing information from a car which is not mounted with a sensor capable of transmitting data with data from a mobile terminal (for example, a smartphone or a mobile phone) which a person in the car carries or to, by detecting where a person or car managed by the server (101) is traveling, distribute advertisement of shops and restaurants on the travel route to the mobile terminal or the car. Therefore, in the case of performing the traffic jam management for cars or advertisement distribution described above using data from terminals persons carry or from vehicles, it becomes possible to reduce the load on a network and the amount of data transmission, or the load on storage and succeeding data processing and enhance the precision of values measured by the sensors used for succeeding data processing.

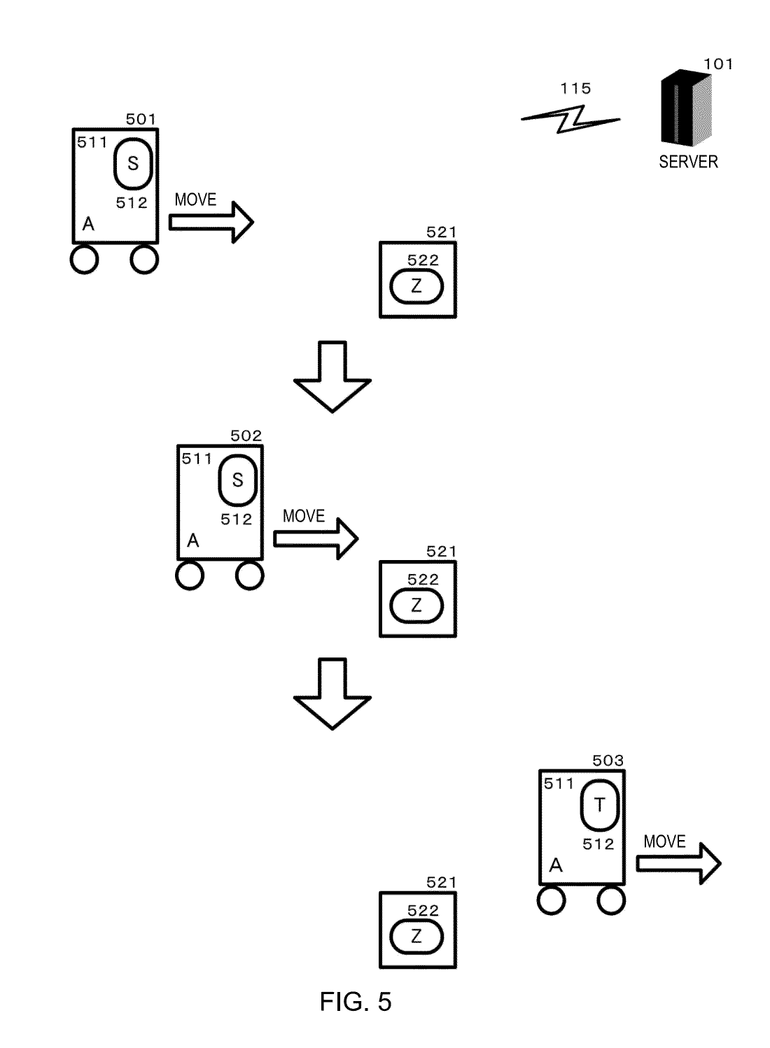

FIG. 5 is a diagram showing, for a solution for measuring or estimating the flow (for example, the traffic volume or traffic density) of cars, motorcycles and the like on each road, a scenario of aggregating data from sensors mounted on the cars, motorcycles and the like, and road-side machines provided with a sensor capable of measuring information about the cars and motorcycles, and performing filter processing, in accordance with the embodiment of the present invention.

Mobile bodies used in the scenario of FIG. 5 are as shown below.
A mobile body is a sensor mounted on a car, and a car A (511) is mounted with a sensor S (512). The sensor S (512) can move accompanying the car A (511). Therefore, the sensor S (512) is the “mobile body” stated in the present invention.
A road-side machine (521) (for example, an ITS (Intelligent Transport System) spot) is installed on a road and provided with a sensor Z (522) capable of measuring information about cars (including the car A (511)) traveling on the road where the road-side machine (521) is installed, for example, the speed, position, acceleration, time and/or movement direction of each car. That is, the sensor Z (522) is capable of measuring data for substituting for or supplementing data from the sensor S (512) mounted on the car A (511).

Information about the sensor S (512) mounted on the car A (511) used in the scenario of FIG. 5 and the sensor Z (522) provided in the road-side machine (521) is as shown below. For example, the information can be implemented as the mobile bodies' relations database shown in FIGS. 6A and 6B described below. However, the information may be managed in a method in accordance with any other data management fashion.

The mobile body type of the sensor S (512) is “car”, “mounted on a car”, and “capable of measuring data with a predetermined precision or at predetermined intervals”.

The mobile body type of the sensor S (512) is “not capable of giving an instruction for controlling data transmission” (data transmission control instruction=No) on the sensor S (512) side, and “not capable of identifying change in the status” of the terminal (status change identification=No) on the sensor S (512) side.

The apparatus type of the sensor Z (522) is “road-side machine”, “capable of collecting passage data of a car”, “installed on a road A”, and “measures data” about a car traveling on the road A “with a predetermined precision or at predetermined intervals”.

The precision of data collected by the sensor Z (522) is assumed to be higher than the precision of data collected by the sensor S (512).

In the scenario of FIG. 5, it is assumed that the car A (511) has not reached a detection range of the sensor Z (522) provided in the road-side machine (521) (501). Initial information about each mobile body in that case is as shown below.
Sensor S (512): mobile body type=car; history of association in the past=none; association of mobile body=none
Sensor Z (522): apparatus (mobile body) type=road-side machine; history of association in the past=none; association of mobile body=none

The server (101) receives data from the sensor S (512) mounted on the car A (511) and data from the sensor Z (522) provided in the road-side machine (521). The data from the sensor S (512) can include, for example, speed, position, acceleration, time and/or movement direction. The data from the sensor Z (522) can include, for example, speed, position, acceleration, time and/or movement direction of each car, especially a combination of speed and position of each car.

On the basis of data from the sensor S (512) mounted on the car A (511), the server (101) calculates the movement vector of the car A (511) (that is, a movement vector equal to the movement vector of the sensor S (512)). Similarly, on the basis of data from sensors mounted on other cars, the server (101) calculates the movement vectors of the other cars.

Furthermore, the server (101) judges on which road the car A (511) is running on the basis of data (for example, position and movement direction) from the sensor S (512) mounted on the car A (511). Furthermore, the server (101) judges which road-side machine the car A (511) is coming near to, on the basis of the data (for example, position and movement direction) from the sensor S (512) and the detected road. Then, the server (101) detects that the car A (511) is coming near to the road-side machine (521).

The server (101) arbitrarily transmits information for notifying the sensor Z (522) which car is coming near, to the sensor Z (522) provided in the road-side machine (521). If the road-side machine (521) is mounted with a camera, the information can be, for example, information capable of identifying the car A (511) (for example, the number or type of the car A (511)). If the road-side machine (521) is mounted with RFID (Radio Frequency Identification), the information can be, for example, a UHF-frequency-band battery-less (passive-type) IC tag mounted on the car A (511), or an identification number specific to the sensor S (512) or an identification number specific to the car A (511). If the road-side machine (521) is mounted with a DSRC (Dedicated Short-Range Communication) antenna, the information can be information from a DSRC in-vehicle apparatus mounted on the car A (511).

It is assumed that the car A (511) comes near to the detection range of the sensor Z (522) provided in the road-side machine (521) (502).

In response to the sensor S (512) (mobile body type=car) coming near to the detection range of the sensor Z (522), the server (101) judges that data from the sensor S (512) and data from the sensor Z (522) can be mutually associated because data about the car A (511) from the sensor S (512) can be replaced with data about the car A (511) from the sensor Z (522). Then, in response to associating the data from the sensor S (512) with the data from the sensor Z (522), the server (101) adds information indicating that the pieces of data have been associated, for example, the information below into, for example, the mobile bodies' relations database (603) shown in FIG. 6C described below. The information about being associated is, for example, as shown below.
Sensor S (512): associated with sensor Z (522); time of being associated with sensor Z (522)
Sensor Z (522): associated with sensor S (512); time of being associated with sensor S (512)

It is not possible to give a transmission control instruction (data transmission control instruction=No) on the sensor S (512) side. The precision of data collected by the sensor Z (522) is higher than the precision of data collected by the sensor S (512). Therefore, the server (101) performs filtering processing shown below for the data from the sensor S (512) and the data from the sensor Z (522). That is, the server (101) replaces the data about the car A (511) from the sensor S (512) with the data about the car A (511) from the sensor Z (522), on the server (101) side. Furthermore, if the data from the sensor Z (522) includes insufficient data or abnormal data, the server (101) does not use the insufficient data and the abnormal data but immediately uses data from the sensor S (512) corresponding to the insufficient data and the abnormal data, as it is. Furthermore, the server (101) deletes or discards the data replaced with the data from the sensor Z (522) among the data from the sensor S (512).

Furthermore, the server (101) can add information about the content of the data filtering processing, for example, the following information into the information about being associated.
Sensor S (512): associated with sensor Z (522); replaced with data of sensor Z (522); replaced data is to be deleted on server (101) side
Sensor Z (522): associated with sensor S (512); provides substitute data to sensor S (512)

The server (101) can add history information shown below indicating that the data from the sensor S (512) and the data from the sensor Z (522) have been mutually associated, into the information about being associated.
Sensor S (512): associated with sensor Z (522); time of being associated with sensor Z (522) (or time of sensor S (512) using data of sensor Z (522))
Sensor Z (522): associated with sensor S (512); time of being associated with sensor S (512)

While the association between the data from the sensor S (512) and the data from the sensor Z (522) is continued (for example, while the car A (511) is traveling within the detection range of the sensor Z (522)), the server (101) substitutes the data from the sensor Z (522) for the data from the sensor S (512). When the server (101) compares the data from the sensor S (512) with the data from the sensor Z (522), and the pieces of data matches each other (for example, information about passage time, position and other information identifying a car), the server (101) replaces the data from the sensor S (512) with the data from the sensor Z (522). Furthermore, the server (101) performs filtering processing of the data from the sensor S (512). That is, the server (101) deletes or discards data replaced with data from the sensor Z (522), among the data from the sensor S (512).

Thus, since the data from the sensor S (512) is replaced with the data from the sensor Z (522), it becomes possible for a user to use high-precision data from the sensor Z (522) as data of the sensor S (512).

The server (101) periodically judges whether the association between the data from the sensor S (512) and the data from the sensor Z (522) can be continued (in other words, whether the association is to be canceled). The server (101) can periodically confirm the movement vector of the car A (511) to judge whether the association between the data from the sensor S (512) and the data from the sensor Z (522) can be continued. Alternatively, the server (101) can detect that the car A (511) is traveling on a road B different from the road A where the road-side machine (521) is installed or traveling outside the detection range of the sensor Z (522) provided in the road-side machine (521), for example, from road information and judge whether the association between the data from the sensor S (512) and the data from the sensor Z (522) can be continued.

It is assumed that the car A (511) has entered a road outside the detection range of the sensor Z (522) provided in the road-side machine (521) (for example, from the road A to another road B) (503).

Because the sensor S (512) mounted on the car A (511) cannot judge itself that the car A (511) has entered another road from the road A (505) (status change identification=No), the server (101) judges that the car A (511) has entered that other road from the road A (505). In response to the car A (511) having entered that other road from the road A (505), the server (101) cancels the association between the data from the sensor S (512) and the data from the sensor Z (522). In response to the association between the data from the sensor S (512) and the data from the sensor Z (522) being to be canceled (403), the server (101) stops filtering processing of the data from the sensor S (512) and stores all the data from the sensor S (512) into the storage medium (108) of the server (101).

In response to the association between the data from the sensor S (512) and the data from the sensor Z (522) having been canceled, the server (101) changes the information about being associated, for example, as shown below.
Sensor S (512): time of car A (511) entering another road from road A (date and time when association with sensor Z (522) ends); history of association in the past=sensor Z (522)
Sensor Z (522): time of car A (511) entering another road from road A (date and time when association with sensor S (512) ends); history of association in the past=sensor S (512)

In response to the cancellation of the association, the server (101) can change the above-described initial information of each mobile body as shown below.
Sensor S (512): mobile body type=car; history of association in the past=sensor Z (522); association of mobile body=none
Sensor Z (522): apparatus (mobile body) type=road-side machine; history of association in the past=sensor S (512); association of mobile body=none

As described above, in the embodiment above, by replacing data from a sensor mounted on a car with data from a sensor capable of measuring information about the car, it becomes possible to measure or estimate the flow of cars on each road, and, further, it becomes possible to reduce the load on a network and the amount of data transmission and reduce the load on the sensor required for succeeding data processing.

The precision of data reported from the sensor Z 522 provided in the road-side machine (521) is higher than the precision of data collected by the sensor S (512) mounted on the car A (511). Therefore, by comparing data collected by the sensor S (512) mounted on the car A (511) with data (for example, speed and position) reported from the sensor Z (522) provided in the road-side machine (521) and using the data reported from the sensor Z (522) as a substitute for the data collected by the sensor S (512), it becomes possible to identify an error (for example, fluctuation for each car which cannot be estimated from static data) of the sensor S (512) mounted on the car A (511) and correct the data collected by the sensor S (512) mounted on the car A (511) using the identified error, during a period during which the sensor S (512) and the sensor provided on the road-side machine are not mutually associated.

The time during which a sensor provided in each car or motorcycle and a sensor provided in a road-side machine are mutually associated is generally very short when the car or motorcycle travels smoothly. However, as described above, by correcting data collected by a sensor mounted on each car or motorcycle using the error identified for the car or motorcycle during a period during which the sensor mounted on the car or motorcycle and a sensor provided in a road-side machine are not mutually associated, it becomes possible to measure or estimate the flow of cars and motorcycles on each road (for example, the traffic volume or the traffic density) more accurately.

An example of dynamically judging association and cancellation of the association while collecting the data from the sensor S (512) mounted on the car A (511) and the data from the sensor Z (522) provided in the road-side machine (521), and performing filtering processing has been shown above. As another implementation method in accordance with the present invention, it is also possible to collect all of the data from the sensor S (512) mounted on the car A (511) and the data from the sensor Z (522) provided in the road-side machine (521) into the server (101) once and then perform filtering processing of at least a part of the data of each sensor at the time of analyzing the flow of cars.

In the above scenarios shown in FIGS. 3, 4 and 5, it has been shown that the present invention is applicable in a solution for following persons' movements in a city, a solution for performing traffic jam management or advertisement distribution and a solution for measuring or estimating the flow of cars on each road (for example, the traffic volume or traffic density), respectively. The present invention is not limited to the above solutions and is also applicable, for example, to the solutions below.
A solution for acquiring information about security, safety, traffic jam prediction and the like
A solution for acquiring information from an in-vehicle apparatus, a car navigator, a road-side apparatus and the like
A solution for acquiring information about pedestrians, bicycles and the like, using a mobile terminal
A solution for acquiring information in the case of a person carrying a mobile terminal getting on a car or a public vehicle such as a bus, a taxi, a train and an airplane
A solution for monitoring or controlling a traffic situation, traffic jam, a flow of cars and a flow of persons
A solution for operation state management by acquiring information about trains, buses and the like
A solution for charging for car sharing
A solution for managing rental goods (for example, cars, bicycles, CDs, videos and DVDs) equipped with a sensor
A solution for managing fixtures equipped with a sensor

FIG. 6A shows an example of a general mobile bodies table (601) for registering mobile body information; and FIG. 6B shows a mobile bodies' relations database which can be used in the embodiment of the present invention.

FIG. 6A shows an example of the general mobile bodies table (601) for registering mobile body information.

The table A (601) shows an example of a general mobile bodies table. The table A (601) has a set of an attribute name, a data type associated with the attribute name and description associated with the attribute name as a record.

The table A (601) can have apparatus (mobile body) ID, apparatus (mobile body) type, apparatus (mobile body) model, mobile body owner ID, parent apparatus (mobile body) ID, each measured value (name, unit, precision, collection interval, minimum value, maximum value and default value), and time of being changed last, as attribute names.

The data type can define the data format of data associated with the attribute name, and arbitrarily define data length of the data.

The description can be, for example, description explaining the attribute name.

The table A (601) can be implemented, for example, with the use of the CIM (Common Information Model) base formulated by the DMTF (Distributed Management Task Force), a system operation management standardization organization. The CIM is an open standard defining a method for expressing management targets in an IT environment by typical objects and relationships among them, and it is possible to consistently manage management targets irrespective of manufacturers.

The table A (601) may be implemented, for example, as a CMDB (Configuration Management Database). In the case where the table A (601) is implemented as a CMDB, each mobile body or each sensor can be managed as one CI (Configuration Item).

FIG. 6B shows examples of a table (602) which includes attribute names for defining attribute values of mobile bodies which can be associated and a table (603) which includes attribute names for storing attribute values of associated mobile bodies, in the mobile bodies' relations database which can be used in the embodiment of the present invention.

The table B (602) can have type of mobile body (apparatus) which can be associated, possible relationship of mobile body (apparatus) which can be associated, possible status of mobile body (apparatus) which can be associated, mobile body type capable of executing a control instruction, mobile body type capable of executing identification of change in the status, and time of being changed last, as attribute names in addition to mobile body (apparatus) type, which is an attribute name common to the table A (601), in order to define mobile bodies which can be associated.

The table B (602) can be used to judge whether a mobile body is a mobile body which can be associated.

The table B (602) may be stored in the storage medium (108) as a table integrated with the table A (601), or the table B (602) may be stored in a storage medium existing at a place different from the storage medium in which the table A (601) is recorded.

The table C (603) has main apparatus (mobile body) ID, subordinate apparatus (mobile body) ID, relationship of associated apparatus (mobile body), and value required for associated apparatus (mobile body), as attribute names in order to define associated mobile bodies.

The table C (603) can be used to record that mobile bodies are mutually associated. The table C (603) can be also used to record that the association of the mutually associated mobile bodies has been canceled.

In the case where all of the table A (601), the table B (602) and the table C (603) are implemented, for example, as configuration management databases (CMDBs), each mobile body or each sensor can be managed as one configuration item (CI).

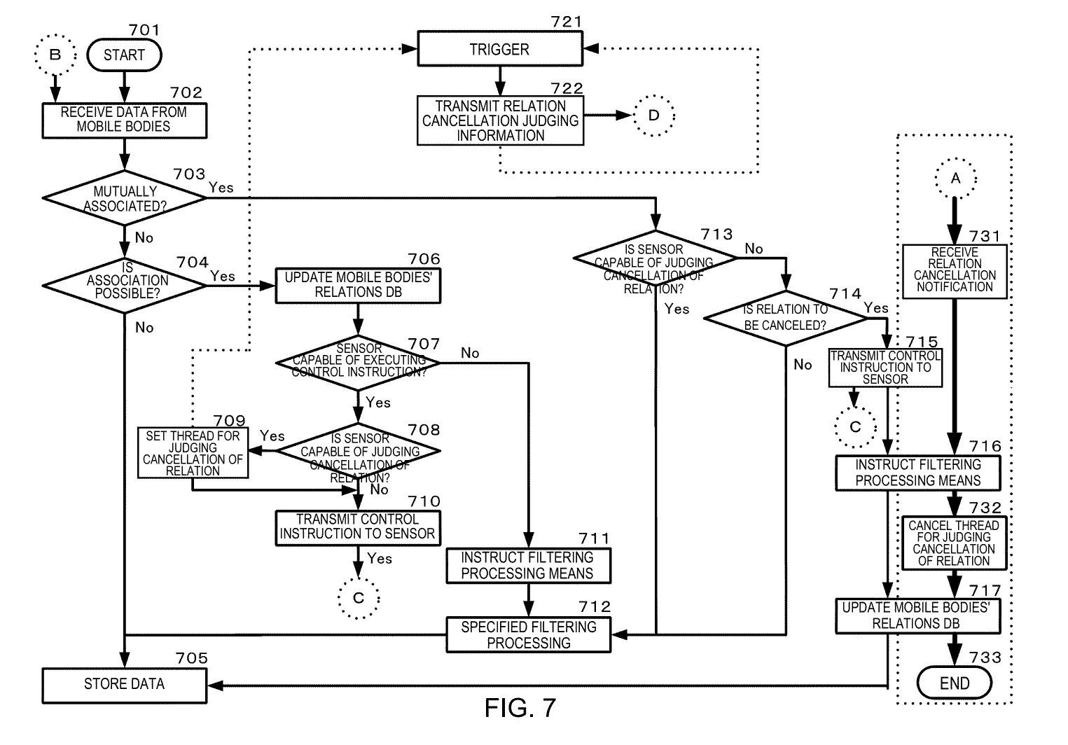

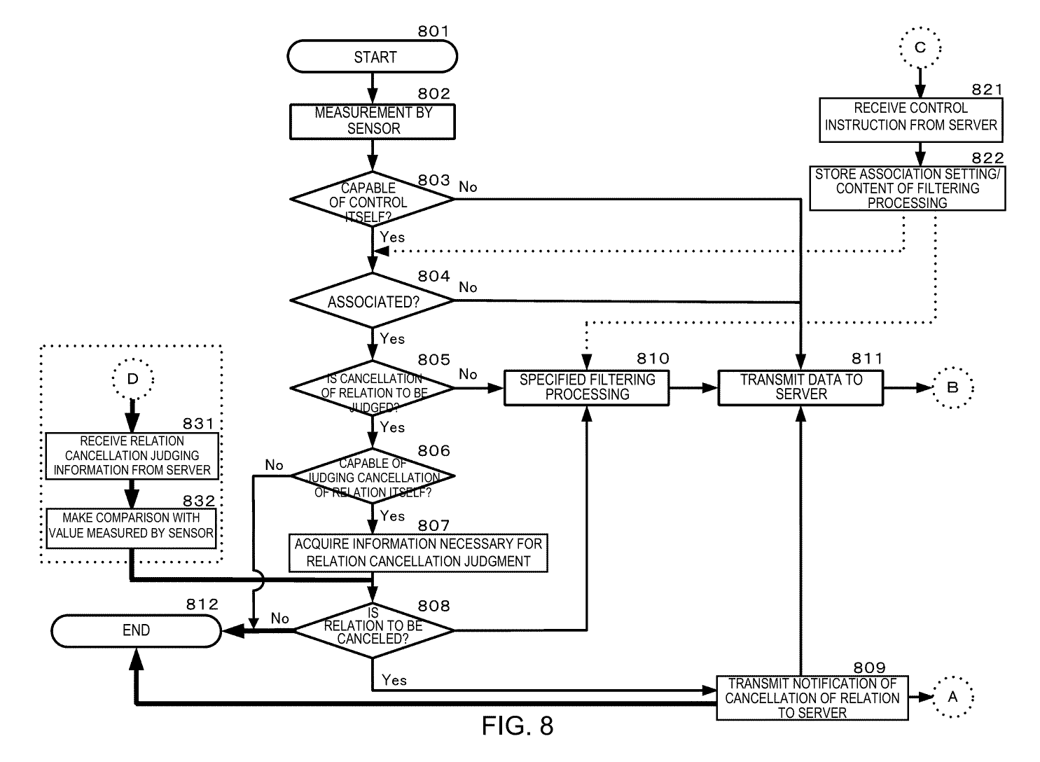

FIGS. 7 and 8 are flowcharts showing examples of a process executed by a server side and a process executed by a sensor side, respectively, in accordance with the embodiment of the present invention. It should be noted that both of the flowcharts merely show an example of the embodiment of the present invention, and the present invention is not limited to the flowcharts.

FIG. 7 is a flowchart showing an example of a process executed by the server side in accordance with the embodiment of the present invention.

At step 701, the server (101) starts to aggregate data from mobile bodies and execute filtering processing.

At step 702, the server (101) receives data from each of the multiple mobile bodies. The server (101) can store the data into, for example, the storage medium (108). Data transmission from each of the multiple mobile bodies to the server can be performed, for example, by the mobile body transmitting data to the server (101) in response to a data transmission request from the server (101) or by the mobile body transmitting data to the server (101) at predetermined time intervals.

At step 702, the server (101) can further receive data from an apparatus (which can be a still apparatus or a mobile apparatus) provided with a sensor capable of measuring information about the mobile body (for example, data for substituting for or supplementing the data from the mobile body) arbitrarily.

At step 703, the server (101) judges whether the mobile body associated with the data received at step 702 or a mobile body associated with data already stored in the storage medium (108) is associated with another mobile body. The server (101) also judges whether data from a sensor provided in the mobile body associated with the data received at step 702 or the mobile body associated with the data already stored in the storage medium (108) is associated with data about the same mobile body from another sensor. The server (101) can perform this judgment, for example, by referring to the mobile bodies' relations database (603) shown in FIG. 6B. In response to the mobile body not being associated with that other mobile body, the server (101) advances the process to step 704. On the other hand, in response to the mobile body being associated with that other mobile body, the server (101) advances the process to step 713. Similarly, in response to the data from the sensor provided in the mobile body not being associated with the data about the same mobile body from that other sensor, the server (101) advances the process to step 704. On the other hand, in response to the data from the sensor provided in the mobile body being associated with the data about the same mobile body from that other sensor, the server (101) advances the process to step 713.

At step 704, if the judgment at step 703 is negative (No), the server (101) judges whether there are at least two mobile bodies which can be mutually associated, among the mobile bodies which transmitted the data received at step 702 or the mobile bodies which transmitted data already stored in the recording medium (108). Similarly, if the judgment at step 703 is negative (No), the server (101) judges whether the data from the sensor provided in each mobile body which transmitted the data received at step 702 and data from the sensor provided in the apparatus capable of measuring information about the mobile body are pieces of data which can be mutually associated.

The server (101) can judge whether the mobile bodies can be associated, for example, on the basis of the following requirements: the positions (for example, GPS information, position information based on a wireless LAN access point (for example, a Wi-Fi access point)) and movement directions (for example, whether the mobile bodies are moving in the same direction and at the same speed or whether the movement vectors of the mobile bodies are the same) of the mobile bodies; the positions and movement speeds of the mobile bodies (speeds which can be determined by comparing earlier data and later data in a certain predetermined period); the mobile bodies table (601) and/or the mobile bodies' relations database (602) with which the mobile bodies are registered; the types of sensors provided in the mobile bodies; mobile bodies which can be associated with the mobile bodies or the sensors provided in the mobile bodies; sensors associated with the mobile bodies or the sensors provided in the mobile bodies; relationship of the mobile bodies or the sensors provided in the mobile bodies (for example, capable of riding, accompanying or the like); detection of a sensor existing around the mobile bodies or the sensors provided in the mobile bodies (for example, detection based on measured values); status conditions of the mobile bodies (for example, being moving, being riding, being stopped or the like); history data of being associated as a related mobile body in the past; or owner information about the mobile bodies.

The server (101) can preferentially judge association between mobile bodies, for example, on the basis of the history data of being associated as a related mobile body in the past or the owner information about the mobile bodies.

Specifically, for example, the server (101) can judge at least two mobile bodies which are performing the same or similar movements and are provided with sensors measuring the same kind of data to be related mobile bodies. The server (101) can judge whether mobile bodies are performing the same or similar movements, from data from the mobile bodies during a predetermined period, for example, current positions, movement speeds or movement vectors of the mobile bodies. For example, the server (101) can judge multiple mobile bodies having similar positions and movement vectors to be related mobile bodies.

The server (101) can judge whether mobile bodies can be mutually associated, for example, by referring to the mobile bodies' relations database (602) shown in FIG. 6B. The server (101) can judge whether mobile bodies can be mutually associated, for example, by referring to that the mobile bodies are riding on a certain mobile body, that mobile bodies are being carried together, or that mobile bodies are moving or being stopped together. As for a technique for identifying whether an apparatus is moving, being stopped, riding or the like from an acceleration sensor or the like, as shown in known prior art. As for a technique for automatically presuming the state of a counterpart, for example, being at rest, being in a conference, being walking, moving in a train or moving in a car, as shown in known prior art.

In response to the fact that there are mobile bodies which can be mutually associated, the server (101) can arbitrarily associate one sensor among sensors provided in the mobile bodies judged to be mutually related, as a main sensor and the other one or multiple sensors as subordinate sensors. The server (101) can perform the above association among the main sensor and the subordinate sensors by referring to the mobile bodies' relations database (602) shown in FIG. 6B. The server (101) stores information about the association among the main sensor and the subordinate sensors into, for example, the mobile bodies' relations database (603) shown in FIG. 6C.

The server (101) can judge whether the data from the sensor provided in each mobile body which transmitted the data received at step 702 and the data from the sensor provided in the apparatus capable of measuring information about the mobile body can be mutually associated, for example, on the basis of the following requirements: whether one of the pieces of data can substitute for the other; history data of being associated as related data in the past; or owner information about the mobile body and the apparatus.

The server (101) can preferentially judge the association between the pieces of data, for example, on the basis of the history data of being associated as related data in the past or the owner information about each of the mobile bodies and the apparatus.

The server (101) can identify whether the association is possible, for example, periodically (for example, at predetermined time intervals).

At step 705, in response to the judgment at step 704 being negative (No), the server (101) stores all the data received at step 702 into the storage medium (108). That is, in response to the judgment at step 704 being negative (No), the server (101) stores all data transmitted from the mobile bodies into the storage medium (108). This is because the filtering processing in accordance with the present invention is not performed because association is not possible.

At step 706, in response to the judgment at step 704 that there are mobile bodies which can be mutually associated or data which can be mutually associated, the server (101) inputs information for the association into, for example, the mobile bodies' relations database (603) and updates the mobile bodies' relations database (603).

At step 707, the server (101) judges whether sensors themselves which are provided in the mutually associated mobile bodies or sensors themselves which transmitted the mutually associated pieces of data are sensors capable of executing a control instruction from the server (101). The control instruction can be, for example, an instruction for setting for association among mobile bodies or an instruction for setting for association among pieces of data; an instruction capable of controlling the kind, precision or acquisition intervals of data collected by the sensors provided in the mobile bodies or the sensor provided in the apparatus; an instruction capable of, in the case where the sensors provided in the mobile bodies or the sensor provided in the apparatus are subordinate sensors, controlling the kind, precision or acquisition intervals of data collected by the subordinate sensors; an instruction for judging cancellation of association among mobile bodies or association among pieces of data (hereinafter referred to as “a relation cancellation judging instruction) on the sensor side; or the content of filtering processing on the sensor side (for example, especially in the case of the sensor being a subordinate sensor, deleting data to the subordinate sensor, not storing data, selecting data, or not transmitting data to the server (101)). In order to judge whether the sensors themselves are sensors capable of executing a control instruction from the server (101), the server (101) can refer to, for example, the mobile bodies' relations database (602) (the attribute name “DATA_CTL_CAP”). In response to the sensors themselves being capable of executing the control instruction, the server (101) advances the process to step 708. On the other hand, in response to the sensors themselves not being capable of executing the control instruction (for example, in the case of primitive sensors), the server (101) advances the process to step 711 (a step of performing filtering processing of data on the server side).

At step 708, the server (101) judges whether the sensors themselves which are provided in the mutually associated mobile bodies or the sensors themselves which are transmitted the mutually associated pieces of data are sensors capable of judging cancellation of the association. In order to judge whether the sensors themselves are sensors capable of judging cancellation of the association, the server (101) can refer to, for example, the mobile bodies' relations database (602) (the attribute name “STATUS_CHANGE_DETECT_CAP”). In response to the sensors themselves being capable of judging cancellation of the association, the server advances the process to step 709 (a step of setting a thread for showing that cancellation of the association is possible on the sensor side). On the other hand, in response to the sensors themselves not being capable of judging cancellation of the association, the server (101) advances the process to step 710 (a step of transmitting a necessary control instruction for performing the association at step 704, to the sensor side).

At step 709, the server (101) sets the thread for showing that it is possible to judge cancellation of the association on the sensor side. Then, the server (101) advances the process to step 721 and waits for a trigger for cancellation of the association.

At step 710, if the judgment at step 708 is positive (Yes), the server (101) transmits the control instruction which includes the relation cancellation judging instruction to the sensors provided in the mutually associated mobile bodies. If the judgment at step 708 is negative (No), the server (101) transmits the control instruction except the relation cancellation judging instruction, to the sensors provided in the mutually associated mobile bodies or the sensors which transmitted the mutually associated pieces of data. As for a process after the sensors receive the control instruction which includes the relation cancellation judging instruction from the server (101) (reference symbol C shown in FIG. 7), see the process after step 821 shown in FIG. 8.

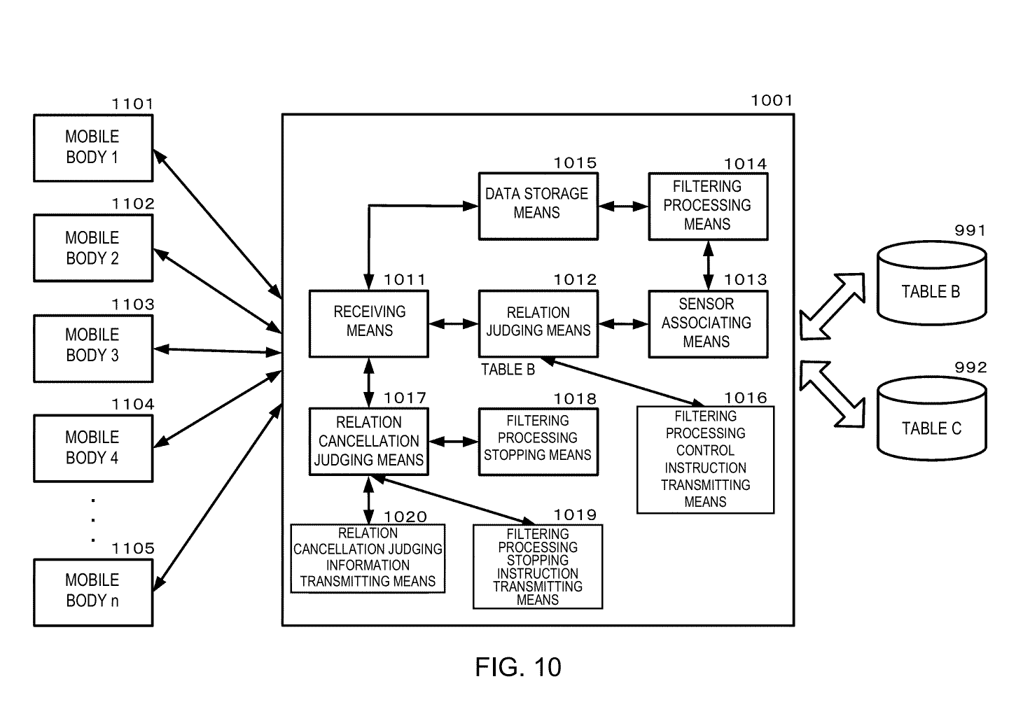

At step 711, in response to the sensors themselves not being capable of executing the control instruction at step 707, filtering processing means (see reference numeral 1014 in FIG. 10 described below) provided in the server is instructed to perform filtering processing for the data received at step 702, data to be received from the mobile bodies in the future, or the data already stored in the storage medium (108). The filtering processing means (see reference numeral 1014 in FIG. 10 described below) can perform the filtering processing, for example, in accordance with a predetermined fashion or a user's instruction. Alternatively, the server (101) can determine the content of the filtering processing by analyzing, for example, overlapping data from sensors measuring the same target data, among the sensors provided in the mutually associated mobile bodies or the sensors which transmitted the mutually associated pieces of data, the precision of data of sensors, existence of an abnormal value in the data, or comparison about collection intervals of the data.

At step 712, on the basis of an instruction from the filtering processing means shown in step 711, the server (101) performs filtering processing. For example, the server (101) can perform filtering processing of a part or all of data from each of at least one (n−1 or fewer) among n (n=integer) sensors or filtering processing of a part of data from each of multiple sensors. Specific content of the filtering processing is, for example, as shown below:
in the case of one and the other sensors among multiple sensors being mutually associated as a main sensor and subordinate sensors, leaving data from the main sensor, and deleting or discarding data from the subordinate sensors;
deleting or discarding overlapping pieces of data among pieces of data to be received or received from the mobile bodies judged to be mutually associated or the pieces of data judged to be mutually associated; for example, storing one piece of data between the overlapping pieces of data from the mobile bodies judged to be mutually associated, into a storage medium while preventing the other piece of data from being stored into the storage medium, or alternatively, storing one piece of data between the overlapping pieces of data among the pieces of data judged to be mutually associated, into a storage medium while preventing the other piece of data from being stored into the storage medium;
leaving data from a high-precision sensor among the pieces of data to be received or received from the mobile bodies judged to be mutually associated or the pieces of data judged to be mutually associated while deleting or discarding data from the other sensors;
comparing collection times of the pieces of data to be received or received from the mobile bodies judged to be mutually associated or the pieces of data judged to be mutually associated, and leaving a part of the pieces of data while deleting or discarding the remaining pieces of data in order that data collection intervals become predetermined collection intervals;
deleting or discarding data showing an abnormal value or data for which an attribute associated with the data is inappropriate among the pieces of data to be received or received from the mobile bodies judged to be mutually associated or the pieces of data judged to be mutually associated;
supplementing the pieces of data to be received or received from the mobile bodies judged to be mutually associated or the pieces of data judged to be mutually associated, with one another to form one data set; or
receiving one piece of data among the pieces of data from the mobile bodies judged to be mutually associated or the pieces of data judged to be mutually associated while preventing the other piece of data from being received.

The server (101) can perform one of the above filtering processes or a combination of a plurality of the filtering processes.

At step 713, the server (101) judges whether the sensors themselves which are provided in the mutually associated mobile bodies or the sensors themselves which are transmitted the mutually associated pieces of data are sensors capable of judging cancellation of the association. The judgment process is performed similarly to step 708. In response to the sensors themselves being capable of judging cancellation of the association, the server (101) advances the process to step 712 (a step of performing filtering processing on the server side). On the other hand, in response to the sensors themselves not being capable of judging cancellation of the association, the server (101) advances the process to step 714 to judge cancellation of the association on the server side.

At step 712, in response to the judgment at step 713 that the sensors are capable of judging cancellation of the association, the server (101) performs filtering processing similar to the instruction from the filtering processing means shown in step 711.

At step 714, the server (101) judges whether the association is to be canceled. In response to the association being to be canceled, the server (101) advances the process to step 715. On the other hand, in response to the association not being to be canceled, the server (101) advances the process to step 712.

The server (101) can judge whether cancellation of the association among the mobile bodies is possible, for example, on the basis of positions and movement directions of the mobile bodies, positions and movement speeds of the mobile bodies (by comparing earlier data and later data in a certain predetermined period), or status conditions of the mobile bodies (for example, being moving, being riding, being stopped or the like).

Specifically, for example, in response to the fact that there is a mobile body performing a different movement among the mobile bodies judged to be mutually associated, the server (101) can judge that cancellation of the association is possible. For example, in the case where three mobile bodies are mutually associated, and two mobile bodies perform the same or similar movements while the remaining one mobile body performs movement different from the movements of the two mobile bodies, the server (101) can cancel the association of only the remaining one mobile body while maintaining the association between the two mobile bodies.

The server (101) can also judge whether cancellation of the association of the mobile bodies is possible, for example, by referring to the mobile bodies' relations database (602) shown in FIG. 6B.

In the case where main sensor/subordinate sensor association is made, the server 101 also cancels the main/subordinate association arbitrarily.

At step 712, in response to the judgment at step 714 that the association of the mobile bodies is not to be canceled, the server 101 performs filtering processing similar to the instruction from the filtering processing means shown in step 711.

At step 715, in response to the association being to be canceled, the server (101) transmits a control instruction which includes a relation cancellation judging instruction, to the sensor. As for a process after the sensor receives the control instruction which includes the relation cancellation judging instruction from the server (101) (reference symbol C shown in FIG. 7), see each process after step 821 shown in FIG. 8. The control instruction can be, for example, an instruction capable of controlling the kind, precision or acquisition intervals of data collected by the sensor provided in the mobile body; an instruction capable of, in the case of the sensor provided in the mobile body being a subordinate sensor, controlling the kind, precision or acquisition intervals of data collected by the subordinate sensor; an instruction for performing relation cancellation judgment on the sensor side (hereinafter also referred to as a “relation cancellation judging instruction”); or the content of filtering processing performed on the sensor side. For example, the content of the filtering processing performed on the sensor side can be, especially in the case where the sensor is a subordinate sensor, to delete data for the subordinate sensor, not to store data, select data, or not to transmit data to the server (101).

At step 716, the server (101) instructs the filtering processing means (see reference numeral 1014 in FIG. 10 described below) provided in the server to stop filtering processing.

At step 717, in response to the judgment at step 714 that the association is to be canceled, the server (101) erases information for the association inputted, for example, in the mobile bodies' relations database (603) and updates the mobile bodies' relations database (603).

At step 705, in response to the update of the mobile bodies' relations database (603) at step 717 having ended, the server (101) stores data after stoppage of the filtering processing, that is, the data received at step 702 into the storage medium (108).

At step 721, the server (101) waits for a trigger for starting a process for judging cancellation of the association on the sensor side. In response to receiving the trigger, the server (101) advances the process to step 722.

At step 722, the server (101) transmits relation cancellation judging information necessary for judging cancellation of the association on the sensor side to the sensor. The relation cancellation judging information can be, for example, information which exists if the association of the mobile body continues; positions and movement directions of related mobile bodies; changes in the positions and movement speeds of the mobile bodies (earlier data and later data in a certain predetermined period); or status conditions of the mobile bodies (for example, being moving, being riding, being stopped or the like). As for a process after the sensor receives the relation cancellation judging information from the server (101) (reference symbol D shown in FIG. 7), see the process after step 831 shown in FIG. 8.

After transmitting the relation cancellation judging information to the sensor, the server (101) returns to step 721 and waits for the trigger.

The process (indicated by thick lines) starting at reference symbol A shown in FIG. 7, advancing through steps 731, 716, 732 and 717 and ending at step 733 shows a process after receiving a relation cancellation notification transmitted at step 809 (a step of notifying the server of relation cancellation in response to the association having been canceled on the sensor side) shown in FIG. 8.

At step 731, the server (101) receives the relation cancellation notification transmitted from the sensor side at step 809.

At step 716, in response to receiving the notification at step 731, the server (101) instructs the filtering processing means (see reference numeral 1014 in FIG. 10 described below) provided in the server to stop filtering processing.

At step 732, the server (101) cancels the relation cancellation judging thread set at step 709 (that is, causes setting of the relation cancellation judging thread to be off). The server (101) may perform the process of step 722 immediately after the process of step 717.

At step 717, in response to canceling the association of the associated mobile bodies at step 809, the server (101) erases information for the association inputted in, for example, the mobile bodies' relations database (603) and updates the mobile bodies' relations database (603).

At step 733, in response to the mobile bodies' relations database (603) being updated at step 717, the server (101) ends the process.

FIG. 8 is a flowchart showing an example of a process executed by a sensor side in accordance with the embodiment of the present invention.

FIG. 8 shows a process implemented by a sensor capable of more intelligent judgment than a sensor performing only measurement of data (for example, steps 803 to 806, and 808 below).

At step 801, the sensor starts a process for measuring data and transmitting the measured data to a server.

At step 802, the sensor measures data by the sensor. Data measurement intervals, measurement precision, measurement content and the like are set in advance or can be dynamically changed by a change instruction by a user or the server.

At step 803, the sensor judges whether the sensor itself can perform control. The sensor can make the judgment, for example, depending on whether the sensor is a sensor capable of executing a control instruction from the server (101). In response to the sensor itself being capable of performing control, the sensor advances the process to step 804. On the other hand, in response to the sensor itself not being capable of performing control, the sensor advances the process to step 811 (a step of transmitting data to the server (101)).

At step 804, the sensor judges whether a mobile body provided with the sensor is associated with another mobile body. Similarly, the sensor judges whether data from the sensor is associated with data from another sensor. In response to the association being made, the sensor advances the process to step 805. On the other hand, in response to the association not being made, the sensor advances the process to step 811.

At step 805, the sensor judges whether or not to judge cancellation of the association. In response to judging cancellation of the association, the sensor advances the process to step 806. On the other hand, in response to not judging cancellation of the association, the sensor advances the process to step 810.

At step 806, the sensor judges whether the sensor itself is capable of judging cancellation of the association. In response to the fact that the sensor itself can judge cancellation of the association, the sensor advances the process to step 807. On the other hand, in response to the fact that the sensor itself cannot judge cancellation of the association, the sensor advances the process to an end step 812.

At step 807, the sensor acquires information necessary for relation cancellation judgment from the server (101). The information necessary for relation cancellation judgment can be, for example, in the case where the sensor is associated with a main sensor and a subordinate sensor, each piece of information of, for example, the position, movement direction and/or movement speed of the main sensor, for example, to be transmitted to the subordinate sensor. Similarly, the information necessary for relation cancellation judgment can be, for example, in the case where the sensor is associated with a main sensor and a subordinate sensor, each piece of information of, for example, the position, movement direction and/or movement speed of the subordinate sensor, for example, to be transmitted to the main sensor. In order to acquire the information, the sensor can transmit a request for transmission of the information to the server (101).

At step 808, the sensor judges whether or not to cancel the association on the basis of the information received at step 807. The sensor can judge whether or not to cancel the association, for example, on the basis of change in the position and movement direction of the mobile body, change in the position and movement speed of the mobile body (by comparing earlier data and later data in a certain predetermined period), or change in the status condition of the mobile body (for example, being moving, being riding, being stopped or the like). As for whether or not to cancel the association, the sensor can judge that the association is to be canceled, for example, in response to occurrence of change in the status condition of the mobile body (for example, being moving, being riding, being stopped or the like). Alternatively, the sensor can judge that the association is to be canceled on the basis of the information necessary for relation cancellation judgment acquired at step 807 and change in the position and movement direction of the mobile body, change in the position and movement speed of the mobile body (by comparing earlier data and later data in a certain predetermined period), or change in the status condition of the mobile body (for example, being moving, being riding, being stopped or the like). Alternatively, the sensor can judge that the association is to be canceled in response to the information necessary for relation cancellation judgment acquired at step 807 not being consistent with the latest data from the sensor corresponding to the information. In response to the association being to be canceled, the sensor advances the process to step 809. On the other hand, in response to the association not being to be canceled, the sensor advances the process to step 810.

At step 809, in response to canceling the association, the sensor transmits a notification of the relation cancellation to the server (101).

After transmitting the notification to the server, the sensor advances the process to step 811 (a process of data transmission to the server (101)). Furthermore, after transmitting the notification to the server, the sensor advances the process to a process succeeding reference symbol A shown in FIG. 7 (that is, a process after the server (101) receives the notification from the sensor).

At step 810, in response to cancellation of the association not being judged at step 805 or in response to the judgment at step 808 that the association is not canceled, the sensor performs instructed filtering processing. The content of the filtering processing can be, for example, as shown below:
in the case of one and the other sensors among multiple sensors being mutually associated as a main sensor and subordinate sensors, in response to the sensor being a subordinate sensor, deleting or discarding data from the subordinate sensor;
deleting or discarding such data which overlaps with or can overlap with data which is being measured or to be measured by another sensor;
in the case of the precision of the sensor being lower in comparison with the sensors of the other mobile bodies, deleting or discarding data from the sensor;
deleting or discarding data showing an abnormal value or data for which an attribute associated with the data is inappropriate among measured data of the sensor; or
among the measured data of the sensor, leaving a part of data and deleting or discarding the remaining data so that data collection intervals become predetermined collection intervals.

The sensor can perform one of the above filtering processes or a combination of a plurality of the filtering processes.

At step 810, in response to the judgment at step 808 that cancellation of the association is not performed, the sensor performs instructed filtering processing. The content of the filtering processing is as stated above.

At step 811, in response to the judgment at step 803 being negative (No) (that is, the sensor itself not being capable of performing control), the sensor transmits all data measured by the sensor or all processed data from the measured data to the server (101).

At step 811, in response to the judgment at step 804 being negative (No) (that is, the sensor itself being capable of performing control but the mobile body provided with the sensor not being associated with another mobile body), the sensor transmits all data measured by the sensor or all processed data from the measured data to the server (101).

At step 811, in response to the relation cancellation notification having been transmitted to the server at step 809, the sensor transmits all the data measured at step 802 or all processed data from the measured data to the server (101) as it is without performing filtering processing.

At step 811, in response to filtering processing having been performed at step 810, the sensor transmits data after the filtering processing to the server (101).

After transmitting the data to the server (101), the process proceeds to a process succeeding reference symbol B shown in FIG. 7 (that is, a process after the server (101) receives the data from the sensor (mobile body)). For the above process succeeding reference symbol B shown in FIG. 7, see each process after step 702 shown in FIG. 7.

At step 812, in response to the judgment at step 806 that the sensor itself is not capable of judging cancellation of the association, the sensor ends the process on the sensor side.

The process starting from reference numeral C shown in FIG. 8 and shown as steps 821 and 822 shows a process performed in response to the sensor receiving the control instruction from step 710 or 715 shown in FIG. 7, from the server (101).

At step 821, the sensor receives the control instruction from step 710 or 715 shown in FIG. 7, from the server (101).

At step 822, the sensor stores association setting into a storage medium (for example, a memory) of the sensor (used at step 804). Furthermore, the sensor stores the content of filtering processing into the storage medium (for example, a memory) of the sensor (used at step 810). The content of filtering processing can be, for example, the content of processing in accordance with the control instruction described at step 707 shown in FIG. 7.

A process starting from reference symbol D shown in FIG. 8 and advancing to step 831, step 832 and then step 808, a process advancing to step 808, step 809 and then step 812, and a process advancing to step 808 and then step 812 show processes performed after receiving the relation cancellation judging information transmitted at step 722 (a step of transmitting the relation cancellation judging information to the sensor) shown in FIG. 7.

At step 831, the sensor receives the relation cancellation judging information from the server (101). The sensor stores the relation cancellation judging information into the storage medium (for example, a memory) of the sensor.

At step 832, the sensor measures the latest data in the sensor or takes out the latest data from the storage medium (for example, a memory) of the sensor. The sensor compares the measured latest data or the taken-out latest data with the relation cancellation judging information. Then, the sensor advances the process to step 808 and judges whether or not to cancel the association on the basis of a result of the comparison.

At step 808, the sensor judges whether or not to cancel the association on the basis of the result of the comparison at step 832. In response to the association being to be canceled, the sensor advances the process to step 809. On the other hand, in response to the association not being to be canceled, the sensor advances the process to an end step 808.

At step 809, in response to canceling the association, the sensor transmits a notification of the relation cancellation to the server (101). Then, after transmitting the relation cancellation notification to the server (101), the sensor advances the process to an end step 812.

At step 812, in response to the relation cancellation notification having been transmitted to the server (101) at step 809, the sensor ends the process on the sensor side.

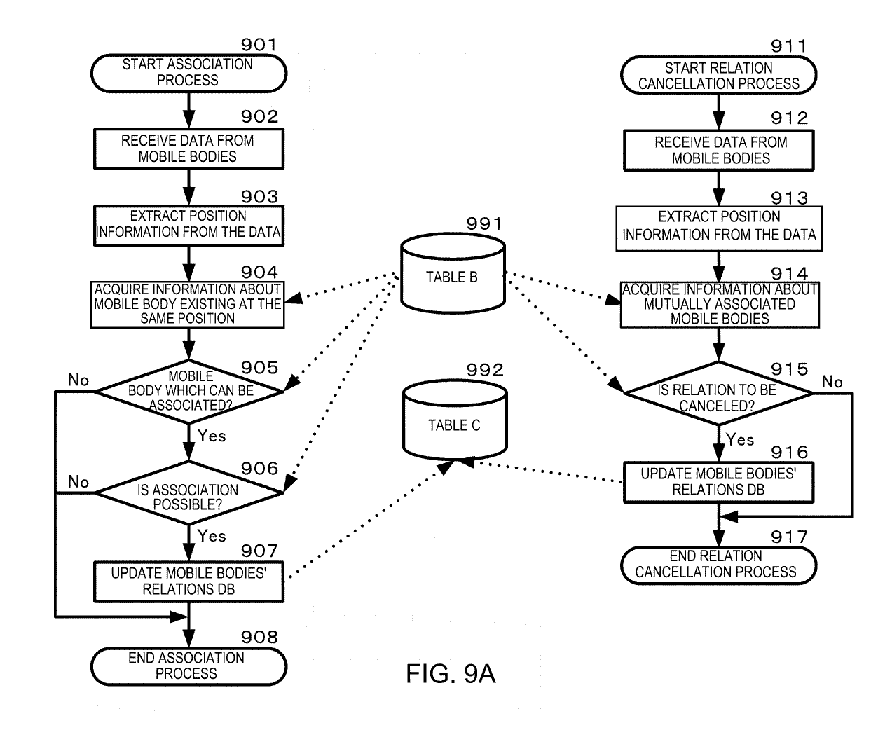

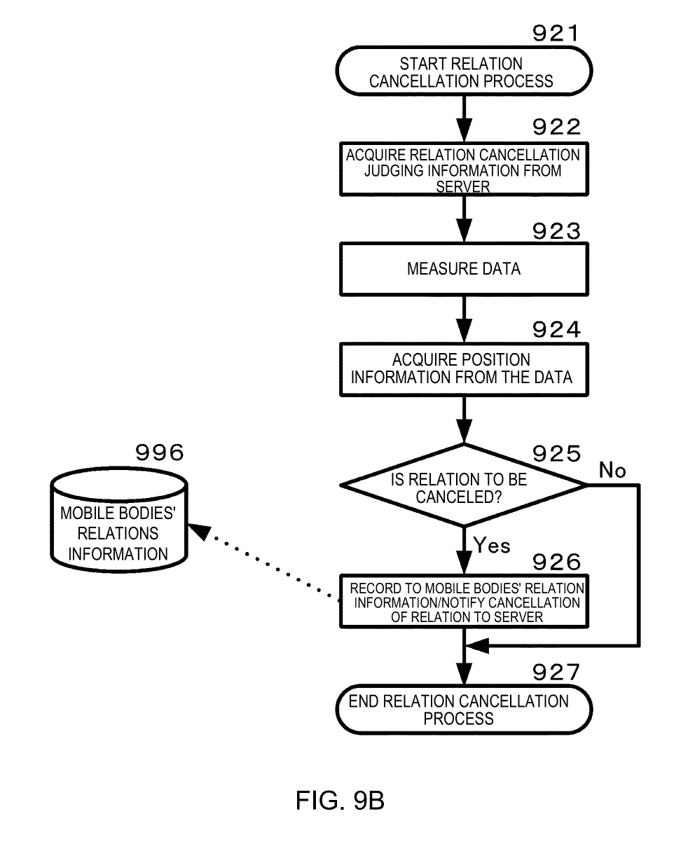

FIG. 9A is a flowchart showing a process for performing the association on the server side and a process for canceling the association on the server side in accordance with the embodiment of the present invention.

Steps 901 to 908 in FIG. 9A show a process for performing the association on the server (101) side.

At step 901, the server (101) starts the process for performing the association among mobile bodies or the association among pieces of data.

At step 902, the server (101) receives data from each of the multiple mobile bodies. The server (101) can store the data into, for example, the storage medium (108). At step 902, the server (101) can further receive data from an apparatus (which can be a still apparatus or a mobile apparatus) provided with a sensor capable of measuring information about the mobile body (for example, data for substituting for or supplementing the data from the mobile body) arbitrarily.

At step 903, the server (101) extracts position information about the mobile body from the data received at step 902. The server (101) can determine the movement vector of the mobile body from the data received at step 902.

At step 904, the server (101) acquires information about another mobile body existing at the same or almost the same position as the mobile body for which the position information has been extracted, from the data received at step 902 or, for example, the table A (for example, the mobile bodies table (601)) and/or the table B (for example, the mobile bodies table (601) or the mobile bodies' relations database (602)). Similarly, the server (101) acquires information about another apparatus existing at the same or almost the same position as the mobile body for which the position information has been extracted, from the data received at step 902 or, for example, the table A (for example, the mobile bodies table (601)) and/or the table B (for example, the mobile bodies table (601) or the mobile bodies' relations database (602)).

At step 905, the server (101) judges whether the mobile body for which the position information has been extracted and at least one mobile body existing at the same or almost the same position as the mobile body are mobile bodies which can be mutually associated. Similarly, the server (101) judges whether data from the mobile body for which the position information has been extracted and data from the apparatus existing at the same or almost the same position as the mobile body can be mutually associated. The server (101) can judge whether the association is possible, for example, from the apparatus type of the mobile body. The server (101) can also judge whether the association is possible, for example, by referring to past history data of being associated as a related mobile body. In response to the association being possible, the server (101) advances the process to step 906. On the other hand, in response to the association not being possible, the server (101) advances the process to an end step 908.

At step 906, in response to the association being possible, the server (101) judges whether the movement vectors of the mobile bodies are the same or almost the same in order to perform the association. Similarly, in response to the association being possible, the server (101) judges whether the movement vectors of and position information about the mobile bodies and position information about the apparatus are within a predetermined range (for example, whether the mobile bodies are positioned within the detection range of the sensor provided in the apparatus) in order to perform the association. In response to the movement vectors being the same or almost the same, the server (101) advances the process to step 907. On the other hand, in response to the movement vectors not being the same or almost the same, the server (101) advances the process to an end step 908.

At step 907, in response to the judgment of the association at step 906, the server (101) inputs information for the association into a table C (992) (for example, the mobile bodies' relations database (603)) and updates the mobile bodies' relations database (603).

At step 908, the server (101) ends the association process.

Steps 911 to 917 in FIG. 9A show a process for canceling association on the server (101) side.

At step 911, the server (101) starts the process for canceling association.

At step 912, the server (101) receives data from each of the multiple mobile bodies. The server (101) can store the data into, for example, the storage medium (108). At step 912, the server (101) can further receive data from an apparatus (which can be a still apparatus or a mobile apparatus) provided with a sensor capable of measuring information about the mobile body (for example, data for substituting for or supplementing the data from the mobile body) arbitrarily.

At step 913, the server (101) extracts position information about the mobile body from the data received at step 912. The server (101) can determine the movement vector of the mobile body from the data received at step 912.

At step 914, the server (101) acquires information about the mutually associated mobile bodies. The information about the mutually associated mobile bodies is information which has been used for judging whether the mobile bodies or the pieces of data can be associated. The information can be taken out, for example, from the table B (for example, the mobile bodies' relations database (602)).

At step 915, the server (101) judges whether or not to cancel the association on the basis of the information acquired at step 914. In response to the association being to be canceled, the server (101) advances the process to step 916. On the other hand, in response to the association not being to be canceled, the server (101) advances the process to an end step 917.

At step 916, in response to the judgment at step 915 that the association being to be canceled, the server (101) erases the information for the association inputted in the table C (992) (for example, the mobile bodies' relations database (603)) and updates the table C (603).

At step 917, the server (101) ends the process for canceling association.

FIG. 9B is a flowchart showing a process for canceling the association on a sensor side in accordance with the embodiment of the present invention.

At step 921, a sensor starts the process for canceling the association.

At step 912, the sensor receives the relation cancellation judging information from the server (101). The sensor stores the relation cancellation judging information into a storage medium (for example, the memory).

At step 923, the sensor measures the latest data in the sensor or takes out the latest data from the storage medium (for example, a memory) of the sensor.

At step 924, the sensor acquires position information about the mobile body provided with the sensor, from the measured latest data or the taken-out latest data.

At step 925, the sensor judges whether or not to cancel the association on the basis of the position information acquired at step 924. In response to the judgment that the association is to be canceled, the sensor advances the process to step 926. On the other hand, in response to the judgment that the association is not to be canceled, the sensor advances the process to an end step 927.

At step 926, in response to the judgment at step 925 that the association is to be canceled, the sensor erases information for the association inputted in mobile bodies' relations information (996) and updates the mobile bodies' relations information (996).

At step 927, the sensor ends the process for canceling association.

FIG. 10 is a diagram showing an example of a functional block diagram of a computer (for example, a server) which is preferably provided with the hardware configuration in accordance with FIG. 1 and which is in accordance with the embodiment of the present invention.

A server (1001) can be connected to at least two mobile bodies. In FIG. 10, the server (1001) is directly or indirectly connected to multiple mobile bodies 1 to n (1101 to 1105) via a network.

The server (1001) is provided with a table B (991) and a table C (992) shown in FIG. 9A or can access a storage medium storing the table B (991) and the table C (992) via the network.

The server (1001) is provided with: receiving means (1011), relation judging means (1012), sensor associating means (1013), filtering processing means (1014), data storage means (1015), filtering processing control instruction transmitting means (1016), relation cancellation judging means (1017), filtering processing stopping means (1018), filtering processing stopping instruction transmitting means (1019) and relation cancellation judging information transmitting means (1020).

From each of the multiple mobile bodies 1 to n (1101 to 1105), the receiving means (1011) receives data from at least one of sensors provided in each of the mobile bodies 1 to n (1101 to 1105). The receiving means (1011) can further receive data from an apparatus (which can be a still apparatus or a mobile apparatus) collecting data from the mobile bodies or data from an apparatus (which can be a still apparatus or a mobile apparatus) provided with a sensor capable of measuring information about the mobile bodies (for example, data for substituting for or supplementing the data from the mobile bodies).

The relation judging means (1012) judges whether at least two mobile bodies among the multiple mobile bodies 1 to n (1101 to 1105) are mutually related, on the basis of the data received by the receiving means (1011). In the case of judging whether at least two mobile bodies among the multiple mobile bodies are mutually related, the relation judging means (1012) can judge mobile bodies performing the same or similar movements to be related mobile bodies. In the case of judging whether at least two mobile bodies among the multiple mobile bodies are mutually related, the relation judging means (1012) can judge mobile bodies to be the related mobile bodies on the basis of past history data of being associated as a related mobile body, a mobile bodies' relations database with which the mobile bodies are registered, status conditions of the mobile bodies or owner information about the mobile bodies.

Furthermore, the relation judging means (1012) judges whether pieces of data about at least one of the mobile bodies (1101 to 1105) from different sensors (for example, one piece of data is data from a sensor provided in the mobile body, and the other is data from an apparatus provided with a sensor capable of measuring information about the one mobile body) are mutually related, on the basis of the data received by the receiving means (1011). In the case of judging whether the pieces of data about at least one mobile body from the different sensors are mutually related, the relation judging means (1012) can judge that the pieces of data from the different sensors are mutually related if the pieces of data from the different sensors are pieces of data about the same mobile body which are for the same purpose, or if the pieces of data from the different sensors are pieces of data about different mobile bodies which are for the same purpose. In the case of judging whether the pieces of data about at least one mobile body from the different sensors are mutually related, the relation judging means (1012) can judge pieces of data to be the mutually related pieces of data on the basis of past history data of pieces of data from the different sensors being mutually associated, a mobile bodies' relations database with which the mobile bodies or an apparatus collecting data from the mobile bodies is registered, the status conditions of the mobile bodies or the apparatus collecting data from the mobile bodies, or owner information about the mobile bodies or the apparatus collecting data from the mobile bodies.

The sensor associating means (1013) associates one sensor as a main sensor with the other sensors, among sensors provided in the mobile bodies judged by the relation judging means (1012) to be mutually related, as subordinate sensors. The sensor associating means (1013) associates one sensor as a main sensor with the other sensors as subordinate sensors, among the different sensors transmitting the pieces of data judged by the relation judging means (1012) to be mutually related.

The filtering processing means (1014) performs filtering processing of at least a part of pieces of data to be received or received from the mobile bodies judged by the relation judging means (1012) to be mutually related. The filtering processing means (1014) also performs filtering processing of at least a part of the pieces of data judged by the relation judging means (1012) to be mutually related.

The filtering processing means (1014) leaves data from the main sensor, and deletes or discards data from the subordinate sensors. The filtering processing means (1014) supplements the data from the main sensor with a part of the data from the subordinate sensors.

The filtering processing means (1014) can delete or discard overlapping pieces of data among the pieces of data to be received or received from the mobile bodies judged to be mutually related or the pieces of data judged to be mutually related. Among the pieces of data to be received or received from the mobile bodies judged to be mutually related or the pieces of data judged to be mutually related, the filtering processing means (1014) can leave data from a high-precision sensor and delete or discard data from the other sensors. The filtering processing means (1014) can compare collection times of the pieces of data to be received or received from the mobile bodies judged to be mutually related or the pieces of data judged to be mutually related and, in order that data collection intervals become predetermined collection intervals, leave a part of the data while deleting or discarding the other data. The filtering processing means (1014) can delete or discard data showing an abnormal value or data for which an attribute associated with the data is inappropriate among the pieces of data to be received or received from the mobile bodies judged to be mutually related or the pieces of data judged to be mutually related. The filtering processing means (1014) can supplement the pieces of data to be received or received from the mobile bodies judged to be mutually related or the pieces of data judged to be mutually related, with one another to form one data set. The filtering processing means (1014) can receive one piece of data between overlapping pieces of data from the mobile bodies judged to be mutually related and prevent reception of the other piece of data.

The data storage means (1015) stores data received by the receiving means (1011) from at least one sensor provided in each of the mobile bodies 1 to n (1101 to 1105) or data received from an apparatus collecting data from the mobile bodies or an apparatus provided with a sensor capable of measuring information about the mobile bodies (for example, data for substituting for or supplementing the data from the mobile bodies), and data filter-processed by the filtering processing means (1014).

The filtering processing control instruction transmitting means (1016) transmits, to at least one sensor provided in the mobile bodies judged by the relation judging means (1012) to be mutually related or at least one sensor among the different sensors transmitting the pieces of data judged to be mutually related, an instruction controlling the sensor to perform filtering processing of the data.

The relation cancellation judging means (1017) judges whether the relation among the mobile bodies judged by the relation judging means (1012) to be mutually related or the relation among the pieces of data judged to be mutually related is to be canceled.

In response to the relation cancellation judging means (1017) judging that the relation among the mobile bodies or the relation among the pieces of data is to be canceled, the filtering processing stopping means (1018) stops the step of performing filtering processing.

In response to the relation cancellation judging means (1017) judging that the relation among the mobile bodies or the relation among the pieces of data is to be canceled, the filtering processing stopping instruction transmitting means (1019) transmits an instruction for stopping filtering processing to the sensor which received the instruction controlling the sensor to perform filtering processing of data from the filtering processing control instruction transmitting means (1016).

In response to the sensor which received the instruction controlling the sensor to perform filtering processing of data from the filtering processing control instruction transmitting means (1016) being capable of canceling the relation among the mobile bodies or the relation among the pieces of data, the relation cancellation judging information transmitting means (1020) transmits information for judging cancellation of the association among the mobile bodies or cancellation of the association among the pieces of data, to the sensor which received the instruction described above.

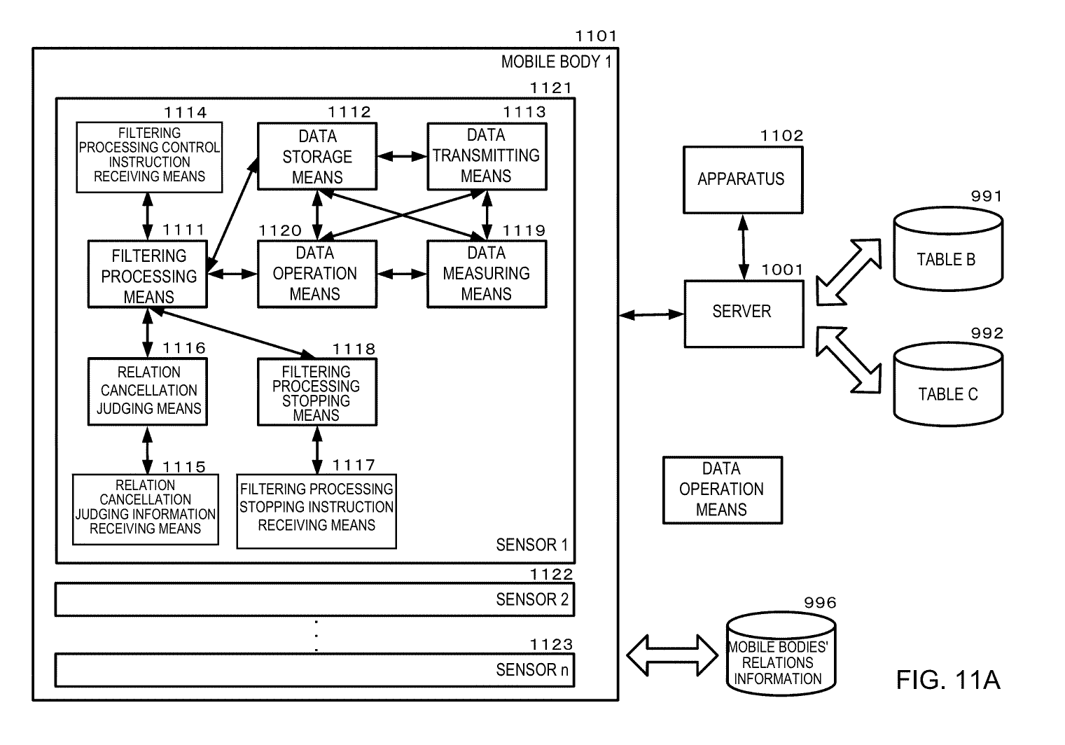

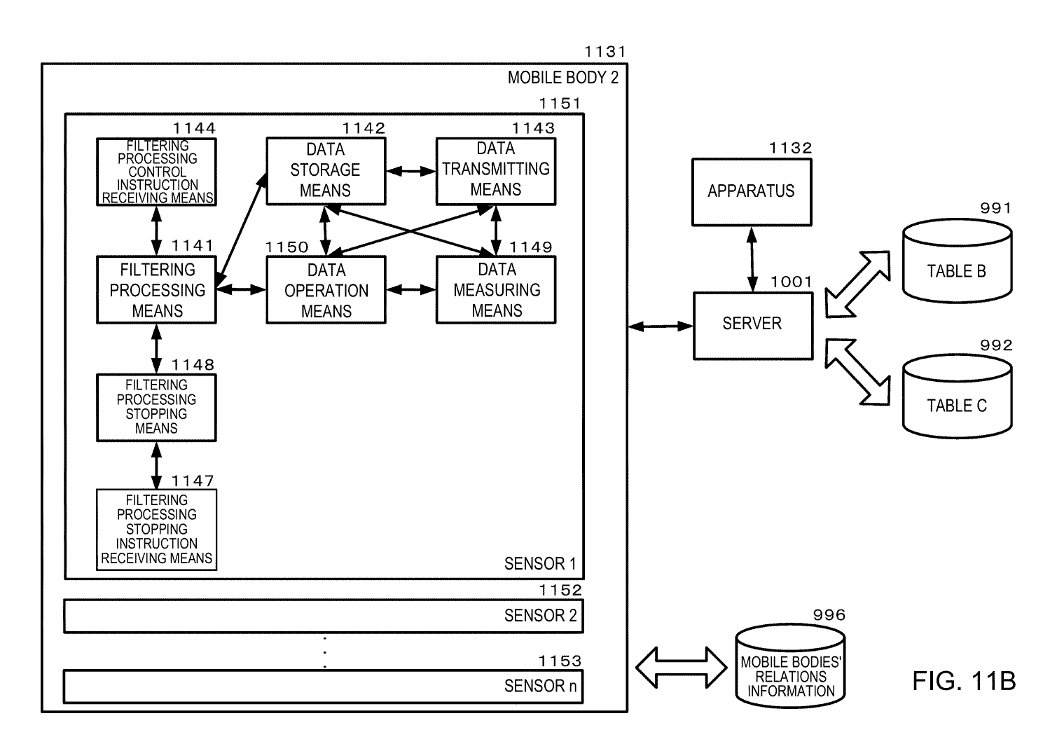

FIGS. 11A and 11B are diagrams showing an example of a functional block diagram of a sensor which can be used in the embodiment of the present invention.

The mobile body 1 (1101) shown in FIG. 11A is provided with multiple sensors 1 to n (1121 to 1123). A functional block diagram of the sensor 1 (1121) will be shown below. The sensor 1 (1121) is assumed to be an intelligent sensor capable of performing filtering processing itself and capable of judging cancellation of the association among mobile bodies judged to be mutually related or the association among pieces of data judged to be mutually related. The other sensors 2 to n (1122 to 1123) may be sensors having functional blocks similar to those of the sensor 1 (1121), sensors having functional blocks similar to those of a sensor 1 (1151) shown in FIG. 11B described below, or sensors having only a data measurement function.

The sensor 1 (1121) is provided with filtering processing means (1111), data storage means (1112), data transmitting means (1113), filtering processing control instruction receiving means (1114), relation cancellation judging information receiving means (1115), relation cancellation judging means (1116), filtering processing stopping instruction receiving means (1117), filtering processing stopping means (1118), data measuring means (1119) and data operation means (1120). The data operation means (1120) is means which can be arbitrarily provided in the sensor 1 (1121).

The filtering processing means (1111) performs filtering processing of at least a part of data measured by the sensor 1 (1121) on the basis of the instruction transmitted from the filtering processing control instruction transmitting means (1016) of the server (1001). In order to transmit data after the filtering processing (that is, data which has not been deleted or discarded) to the server (1001), the filtering processing means (1111) hands over the data after the filtering processing to the data transmitting means (1113).

The data storage means (1112) stores the data measured by the sensor 1 (1121) and the data filtering-processed by the filtering processing means (1111).

The data transmitting means (1113) transmits data measured by the data measuring means (1119) or data obtained by processing the data, or the data filtering-processed by the filtering processing means (1111) (that is, the data which has not been deleted or discarded) to the server (1001).

The filtering processing control instruction receiving means (1114) receives the instruction transmitted from the filtering processing control instruction transmitting means (1016) of the server (1001). The filtering processing control instruction receiving means (1114) can specify the content of filtering processing to the filtering processing means (1111) on the basis of an instruction performing control so that data is filtering-processed. The filtering processing control instruction receiving means (1114) can also specify data to be measured, to the data measuring means (1119) on the basis of the instruction performing control so that data is filtering-processed.

The relation cancellation judging information receiving means (1115) receives the information transmitted from the relation cancellation judging information transmitting means (1020) of the server (1001).

The relation cancellation judging means (1116) judges whether the relation among the mobile bodies judged to be mutually related or the relation among the pieces of data judged to be mutually related is to be canceled, using the information received by the relation cancellation judging information receiving means (1115) and the latest data measured by the data measuring means (1119).

The filtering processing stopping instruction receiving means (1117) receives the instruction transmitted from the filtering processing stopping instruction transmitting means (1019) of the server (1001).

In response to the relation cancellation judging means (1116) having judged that the relation among the mobile bodies judged to be mutually related or the relation among the pieces of data judged to be mutually related is to be canceled, the filtering processing stopping means (1118) stops filtering processing by the filtering processing means (1111).

The data measuring means (1119) performs a process for converting change in a physical quantity or a chemical quantity to an electrical signal, which is the original function of a sensor.

The data operation means (1120) converts measurement data measured by the data measuring means (1119) or image data to processed data.

An apparatus (1102) (with an arbitrary configuration) shown in FIG. 11A is an apparatus provided with a sensor capable of measuring information about a mobile body (for example, data for substituting for or supplementing data from the mobile body). The sensor provided in the apparatus (1102) can have functional blocks similar to those of the sensors 1 to n (1121 to 1123) provided in the mobile body 1 (1101).

A mobile body 2 (1131) shown in FIG. 11B is provided with multiple sensors 1 to n (1151 to 1153). A functional block diagram of the sensor 1 (1151) will be shown below. The sensor 1 (1151) is assumed to be an intelligent sensor capable of performing filtering processing itself. The other sensors 2 to n (1152 to 1153) may be sensors having functional blocks similar to those of the sensor 1 (1151), sensors having functional blocks similar to those of the sensor 1 (1121) shown in FIG. 11A, or sensors having only a data measurement function.

The sensor 1 (1151) is similar to the sensor 1 (1121) shown in FIG. 11A in that it is provided with filtering processing means (1141), data storage means (1142), data transmitting means (1143), filtering processing control instruction receiving means (1144), filtering processing stopping instruction receiving means (1147), filtering processing stopping means (1148), data measuring means (1149) and data operation means (1150) (arbitrarily). However, the sensor 1 (1151) is different from the sensor 1 (1121) shown in FIG. 11A in that the sensor 1 (1151) is neither provided with the relation cancellation judging information receiving means (1115) nor the relation cancellation judging means (1116) provided in the sensor 1 (1121). That is, the sensor 1 (1151) is a sensor which is capable of data filtering processing on the sensor side but is not capable of judging cancellation of the association among mobile bodies judged to be mutually related and cancellation of the association among pieces of data judged to be mutually related.

An apparatus (1132) (with an arbitrary configuration) shown in FIG. 11B is an apparatus provided with a sensor capable of measuring information about an mobile body (for example, data for substituting for or supplementing data from the mobile body). The sensor provided in the apparatus (1132) can have functional blocks similar to those of the sensors 1 to n (1151 to 1153) provided in the mobile body 2 (1131).

The object of the present invention is to dynamically associate multiple mobile bodies or pieces of data about at least one mobile body from different sensors and perform filtering processing of pieces of data from the mutually associated mobile bodies or the mutually associated pieces of data.

The present invention is a technique for aggregating pieces of data from mobile bodies each of which is provided with at least one sensor and performing filtering processing, and the technique includes: receiving pieces of data from the multiple mobile bodies; judging whether at least two mobile bodies among the multiple mobile bodies or pieces of data about at least one mobile body from different sensors are mutually related, on the basis of the received pieces of data; and performing filtering processing of at least a part of the pieces of data from the mobile bodies judged to be mutually related or at least a part of the pieces of data judged to be mutually related.

What is claimed is:

1. A method for aggregating data from movable devices, wherein each of the movable devices comprises at least one sensor, wherein each of the movable devices is capable of performing filtering processing, and wherein the method comprises:
receiving, by one or more processors, data from multiple movable devices, wherein each datum from the data is generated by at least one sensor within a movable device from the multiple movable devices;
determining, by one or more processors and based on received data from the multiple movable devices, whether at least two movable devices from the multiple movable devices are mutually related;
determining, by one or more processors and based on received data from the multiple movable devices, whether the received data from different sensors are mutually related; and
filtering, by one or more processors, at least a part of the data from the multiple movable devices judged to be mutually related and that was generated by sensors that are mutually related according to shared attributes of the multiple movable devices and the sensors in the multiple movable devices.

2. The method according to claim 1, further comprising:
defining, by one or more processors, a first sensor from a first movable device as a main sensor;
defining, by one or more processors, multiple second sensors from the multiple movable devices as subordinate sensors; and
mutually associating, among different sensors provided in the multiple movable devices judged to be mutually related and among the different sensors transmitting the data judged to be mutually related, the main sensor with the subordinate sensors.

3. The method according to claim 2, further comprising:
retaining, by one or more processors, all data from the main sensor while deleting all data from the subordinate sensors.

4. The method according to claim 2, further comprising:
supplementing, by one or more processors, data from the main sensor with a portion of data from the subordinate sensors.

5. The method according to claim 1, further comprising:
determining, by one or more processors, whether a relation among the multiple movable devices judged to be mutually related and a relation among the data judged to be mutually related is to be canceled, wherein said determining is based on contents of the data received from the multiple movable devices; and
in response to the relation among the multiple movable devices judged to be mutually related and the relation among the data judged to be mutually related being reversed, such that the relation is canceled, stopping, by one or more processors, said filtering of at least a part of the data from the multiple movable devices judged to be mutually related.

6. The method according to claim 5, wherein cancellation of the relation among the multiple movable devices judged to be mutually related is performed in response to a movable device physically moving in a different direction than other movable devices that were previously judged to be mutually related.

7. The method according to claim 1, further comprising:
identifying, by one or more processors, a first movable device that is performing a same physical movement as other related movable devices; and
determining, by one or more processors, that the first movable device and the other related movable devices are related based on past history data describing past movement and ownership of the first movable device and the other related movable devices.

8. The method according to claim 1, further comprising:
retaining, by one or more processors, received data from a high-precision sensor while deleting received data from other sensors, wherein the other sensors have been predetermined to not be as precise as the high-precision sensor in generating sensor data, and wherein the received data from the high-precition sensor is retained in a storage device;
deleting, by one or more processors, any data that shows a value that has been predetermined to be abnormal for a particular movable device, wherein said any data is deleted from the storage device;
comparing, by one or more processors, collection times of data from the movable device judged to be mutually related;
retaining within the storage device, by one or more processors, only received data that is collected by the multiple moveable devices within a predetermined collection interval; and
combining, by one or more processors, received data that is deemed to be mutually related with data that is deemed to be mutually unrelated into a single data set.

9. An apparatus for aggregating data from movable devices, wherein each of the movable devices comprises at least one sensor, wherein each of the movable devices is capable of performing filtering processing, and wherein the apparatus comprises:
a hardware receiver for receiving data from multiple movable devices, wherein each datum from the data is generated by at least one sensor within a movable device from the multiple movable devices;
a first hardware determining device for determining, based on received data from the multiple movable devices, whether at least two movable devices from the multiple movable devices are mutually related;
a second hardware determining device for determining, based on received data from the multiple movable devices, whether the received data from different sensors are mutually related; and
a filtering hardware device for filtering at least a part of the data from the multiple movable devices judged to be mutually related and that was generated by sensors that are mutually related according to shared attributes of the multiple movable devices and the sensors in the multiple movable devices.

10. The apparatus according to claim 9, further comprising:
a first hardware defining device for defining a first sensor from a first movable device as a main sensor;
a second hardware defining device for defining multiple second sensors from the multiple movable devices as subordinate sensors; and
an associating hardware device for mutually associating, among different sensors provided in the multiple movable devices judged to be mutually related and among the different sensors transmitting the data judged to be mutually related, the main sensor with the subordinate sensors.

11. The apparatus according to claim 10, further comprising:
a retaining hardware device for retaining all data from the main sensor while deleting all data from the subordinate sensors.

12. The apparatus according to claim 10, further comprising:
a supplementing hardware device for supplementing data from the main sensor with a portion of data from the subordinate sensors.

13. The apparatus according to claim 9, further comprising:
a first retaining hardware device for retaining received data from a high-precision sensor while deleting received data from other sensors, wherein the other sensors have been predetermined to not be as precise as the high-precision sensor in generating sensor data, and wherein the received data from the high-precision sensor is retained in a storage device;
a deleting hardware device for deleting any data that shows a value that has been predetermined to be abnormal for a particular movable device, wherein said any data is deleted from the storage device;
a comparing hardware device for comparing collection times of data from the multiple movable devices judged to be mutually related;
a second retaining hardware device for retaining within the storage device only received data that is collected by the multiple moveable devices within a predetermined collection interval; and
a combining hardware device for combining received data that is deemed to be mutually related with data that is deemed to be mutually unrelated into a single data set.

14. A computer program product for aggregating data from multiple movable devices, wherein each of the multiple movable devices comprises at least one sensor, wherein each of the multiple movable devices is capable of performing filtering processing, wherein the computer program product comprises a computer readable medium having program code embodied therewith, wherein the computer readable storage medium is not a transitory signal per se, and wherein the program code is readable and executable by a processor to perform a method comprising:
receiving data from the multiple movable devices, wherein each datum from the data is generated by at least one sensor within a movable device from the multiple movable devices;
determining, based on received data from the multiple movable devices, whether at least two movable devices from the multiple movable devices are mutually related;
determining, based on received data from the multiple movable devices, whether the received data from different sensors are mutually related; and
filtering at least a part of the data from the multiple movable devices judged to be mutually related and that was generated by sensors that are mutually related according to shared attributes of the multiple movable devices and the sensors in the multiple movable devices.

15. The computer program product of claim 14, wherein the method further comprises:
defining a first sensor from a first movable device as a main sensor;
defining multiple second sensors from the multiple movable devices as subordinate sensors; and
mutually associating, among different sensors provided in the multiple movable devices judged to be mutually related and among the different sensors transmitting the data judged to be mutually related, the main sensor with the subordinate sensors.

16. The computer program product of claim 15, wherein the method further comprises:
retaining all data from the main sensor while deleting all data from the subordinate sensors.

17. The computer program product of claim 15, wherein the method further comprises:
supplementing data from the main sensor with a portion of data from the subordinate sensors.

18. The computer program product of claim 14, wherein the method further comprises:
determining whether a relation among the multiple movable devices judged to be mutually related and a relation among the data judged to be mutually related is to be canceled, wherein said determining is based on contents of the data received from the multiple movable devices; and
in response to the relation among the multiple movable devices judged to be mutually related and the relation among the data judged to be mutually related being reversed, such that the relation is canceled, stopping said filtering of at least a part of the data from the multiple movable devices judged to be mutually related.

19. The computer program product of claim 18, wherein cancellation of the relation among the multiple movable devices judged to be mutually related is performed in response to a movable device physically moving in a different direction than other movable devices that were previously judged to be mutually related.

20. The computer program product of claim 14, wherein the method further comprises:
retaining received data from a high-precision sensor while deleting received data from other sensors, wherein the other sensors have been predetermined to not be as precise as the high-precision sensor in generating sensor data, and wherein the received data from the high-precision sensor is retained in a storage device;
deleting any data that shows a value that has been predetermined to be abnormal for a particular movable device, wherein said any data is deleted from the storage device;
comparing collection times of data from the multiple movable devices judged to be mutually related;
retaining within the storage device only received data that is collected by the multiple movable devices within a predetermined collection interval; and
combining received data that is deemed to be mutually related with data that is deemed to be mutually unrelated into a single data set.
